(19) United States
(12) Patent Application Publication
(10) Pub. No.: US 2018/0112121 A1
(43) Pub. Date: Apr. 26, 2018

(54) POLYMERIC COMPOSITIONS AGGLOMERATING COMPOSITIONS, MODIFIED SOLID MATERIALS, AND METHODS FOR MAKING AND USING SAME

(71) Applicant: Lubrizol Oilfield Solutions, Inc., Wickliffie, OH (US)

(72) Inventors: Leonid Vigderman, Houston, TX (US); Duane S. Treybig, Spring, TX (US); Rajesh K. Saini, Houston, TX (US)

(21) Appl. No.: 15/567,464

(22) PCT Filed: May 25, 2016
(86) PCT No.: PCT/US2016/034065

§ 371 Date: Oct. 18, 2017

Related U.S. Application Data
(60) Provisional application No. 62/166,722, filed on May 27, 2015.

(51) Int. Cl. C09K 8/575; C09K 8/80

(52) U.S. Cl. CPC C09K 8/5756; E21B 43/025; C09K 8/805

(57) ABSTRACT

Aggregating composition including oligomers and/or polymeric comprising amine containing repeat units, non-amine containing groups units, ammonium containing repeat units, amine oxide containing repeat units, or mixtures and combinations thereof, where relative amounts of the amine containing repeat units, the non-amine containing groups units, the ammonium containing repeat units, and the amine oxide containing repeat units and/or the relative amount of the oligomers and/or polymers are tailored to the exact requirements of the formation, zone, particles and/or structure to be treated and where the composition forms partial, substantially complete, and/or complete coatings on the particles, surfaces and/or materials altering their self-aggregating properties and/or aggregation propensities and/or zeta potentials and methods for making and using the compositions.

### BACKGROUND OF THE INVENTION

### Field of the Invention

Embodiments of the present invention relate to: (1) aggregating compositions for treating solid materials, surfaces, and/or substrates, where the compositions of the aggregating compositions are tailored and/or optimized to the specific characteristics and properties of the formation surfaces, formation particulates, and/or downhole fluid particulates to be treated, (2) solid materials treated with the aggregating compositions; and (3) methods for making and using same.

More particularly, embodiments of the present invention relates to aggregating compositions for particulate solid materials, surfaces, and/or substrates that alter, modify, and/or change surface properties of the materials, surfaces, and/or substrates increasing their aggregating propensity or properties and treated materials, where the aggregating compositions include an oligomeric amine (oligoamine), an polymeric amine (polyamine), or mixtures and combinations thereof. The present invention also relates to methods for augmenting, altering, changing, and/or modifying aggregation propensities and/or zeta potentials of materials, surfaces, and/or substrates especially in downhole and other applications, where the methods involve treating a formation, a formation zone, a sand control system, a proppant, or other solid materials with the compositions of this invention augmenting, changing, altering and/or modifying aggregation propensities of the formation, zone, sand control system, proppant or other material.

### Description of the Related Art

Sand production is a major problem in lot of oil wells because it can erode/plug surface equipments, screens and tubulars. Overtime this can lead to loss of well and/or costly maintenance or workover operations. In other cases, proppant (sand or other types) used during a fracturing operation may flow back and also cause problems.

Sand control is typically achieved using mechanical means such as metal screens, gravel pack, frack pack, horizontal gravel pack, etc. In addition, chemical sand consolidation techniques may be using chemicals that alter surface zeta potential, pumping sticky or tacky material (e.g., SandWedge products of Halliburton), or using resin-coated frac- or gravel-pack sand. The Halliburton technology utilizes “tacky” compounds including polyacids and reaction products of polyacids and polyamines (generally dimers and trimers or both). See e.g., U.S. Pat. No. 5,501,274, 5,582,249, 5,697,440, 5,775,425, 5,833,000, 5,787,986, 5,853,048, 5,871,049, and 7,258,170, and United States Published Patent Application No. 20050277554. These compounds may be applied to frac- or gravel-pack sand or pumped separately into a formation. Other compounds includes thermoset resin including epoxy, furan or phenolic resin are also used for sand control applications.

U.S. Pat. No. 7,392,847 B2 discloses compositions that agglomerate sand by reducing its zeta potential. The current chemistry utilizes a mixture of a small-molecule amine and a phosphate ester. These molecules are less environmentally friendly and may have an associated toxicity or smell. In addition, this chemistry is less effective for positive surfaces such as calcium carbonate.

Although these products are useful for aggregating or agglomerating particulates and treating formation surfaces to alter a zeta potential of the surfaces and/or particles, there is still an need in the art for products that can augment aggregating or agglomerating properties of particles and/or surfaces and/or augment zeta potentials of particles and/or surfaces, especially aggregating compositions that can be tailored to the materials to be treated.

### SUMMARY OF THE INVENTION

(a) oligomers and/or polymers including amine containing repeat units, quaternized amine containing repeat units, N-oxide containing repeat units, or mixtures and combinations thereof; (b) epoxy modified amines, epoxy-amine oligomers, epoxy-amine polymers, or mixtures and combinations thereof; (c) epoxy modified amines, epoxy-amine oligomers, epoxy-amine polymers, or mixtures and combinations thereof including quaternized amine groups, N-oxide containing groups, or mixtures and combinations thereof; and (d) mixtures or combinations thereof.

### Compositions

Embodiments of the present invention provide aggregating compositions for treating solid particles, surfaces and/or materials, where the aggregating compositions comprise: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The compositions are capable of forming partial, substantially complete, and/or complete coatings on the solid particles, surfaces and/or materials depending on the properties of the solid particles, surfaces and/or materials to be treated. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may also include repeat units of non-amine containing ethylenically unsaturated polymerizable monomers (vinyl and diene monomers). In certain embodiments, the aggregating compositions of this invention include reaction products of the aggregating compositions of this invention with an acid containing compound that forms a negative charge upon deprotonation, such as, for example, acidic nitrogen containing compounds, or an acidic hydroxyl containing compound, a Lewis acid and mixtures or combinations thereof. Examples of the acidic hydroxyl containing compounds include phosphate esters, methylene phosphonic acids, sulfonic acids, mineral acids and organic acids. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The aggregating compositions can also include a crosslinking agent. The aggregating composition can additionally include resin. The aggregating compositions of this invention are believed to form complete, substantially complete, and/or partial coatings on the particles, surfaces, and/or materials altering self-aggregating properties, and/or aggregation propensities of the particles, surfaces, and/or materials. In certain embodiments, the oligomers and polymers may be of any form from homooligomers, homopolymers, random cooligomers, random copolymers, fully blocked cooligomers, fully blocked copolymers, partially blocked cooligomers, partially blocked copolymers, random, fully blocked, and/or partially blocked oligomers and polymers including three or more different type of monomeric repeat units, any other combination of two or more monomeric repeat units, or mixtures and combinations thereof to achieve desired properties so that the compositions forms partially or complete zeta altering coatings on specific formation surfaces, specific formation particles, and/or specific proppants. In other embodiments, the compositions include oligomers and/or polymers having differing amounts of non-amine containing monomeric repeat units, amine containing monomeric repeat units, quaternary amine containing monomeric repeat units, and N-oxide containing monomeric repeat units, where the amounts are adjusted so that the compositions are tailored to have specific properties to form coatings on specific solid materials, surfaces and/or substrates. The tailoring may also be based on different amounts of different oligomers and/or polymers in the formulation.

Embodiments of the present invention provide particles, surfaces, and/or materials including partial, substantially complete, and/or complete coatings of an aggregating composition of this invention, where the partial, substantially complete, and/or complete coatings alters self-aggregating properties, and/or aggregation propensities of the particles, surfaces, and/or materials.

Embodiments of the present invention provide coatings of aggregating compositions comprise: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may also include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. Examples of the acidic hydroxyl containing compounds include phosphate esters, methylene phosphonic acids, sulfonic acids, mineral acids, and organic acids. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials.

Embodiments of the present invention provide a structure and/or substrate having surfaces partially, substantially completely, and/or completely coated with aggregating compositions that comprise: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N- oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. Examples of the acidic hydroxyl containing compounds include phosphate esters, methylene phosphonic acids, sulfonic acids, mineral acids and organic acids. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials. The coatings are deformable and ideally suited for filtering fines and/or other particulate materials form a fluid, especially fluids used in oil/gas well drilling, completion, production, fracturing, propping, other production enhancing processes or other related applications. The substrates and/or structures can be ceramic and/or ceramic fibers or wools coated partially or completely with the compositions of this invention. Such substrates or structures are well suited for filter media to be used with or without screens.

### Method for Treating

Embodiments of the present invention provide methods for changing, altering, and/or modifying an aggregation potential or propensity of a solid particles, surfaces, and/or materials, where the method includes the step of contacting the particles, surfaces, and/or materials with a composition comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof The effective is sufficient to render the compositions capable of forming partial, substantially complete, and/or complete coatings on the solid particles, surfaces and/or materials depending on the properties of the solid particles, surfaces and/or materials. The oligomeric and/or polymeric amines include repeat units of ethylenically unsaturated polymerizable monomers (e.g., vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (e.g., vinyl and diene monomers). In certain embodiments, the aggregating compositions of this invention may also include reaction products of the amines of this invention with an acidic hydroxyl containing compound or a Lewis acid. Examples of the acidic hydroxyl containing compounds include phosphate esters, methylene phosphonic acids, sulfonic acids, mineral acids and organic acids. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials.

### Methods for Using the Treating Methods

### Fracturing

Embodiments of the present invention provide methods for fracturing a formation including the step of pumping a fracturing fluid including a proppant into a producing formation at a pressure sufficient to fracture the formation and to enhance productivity, where the proppant props open the formation after fracturing and where the proppant comprises a solid particles treated with treating compositions comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials.

Embodiments of the present invention provide methods for fracturing a formation including the step of pumping a fracturing fluid including a proppant and aggregating compositions comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and an acidic hydroxyl containing compound or a Lewis acid. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials.

Embodiments of the present invention provide methods for fracturing a formation including the step of pumping a fracturing fluid including aggregating compositions comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials. The composition results in a altering an aggregation propensity, potential and/or zeta-potential of the formation particles and/or formation surfaces so that the formation particles aggregate and/or cling to the formation surfaces. The methods may also include the step of pumping a proppant comprising a uncoated and/or coated particles after fracturing so that the particles prop open the fracture formation and where the coated particles tend to aggregate on the formation surfaces and/or formation particles formed during fracturing.

### Drilling

Embodiments of the present invention provide methods for drilling including the step of while drilling, circulating a drilling fluid, to provide bit lubrication, heat removal and cutting removal, where the drilling fluid includes aggregating compositions comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials. The compositions alters an aggregation potential or propensity and/or a zeta potential of particulate materials in the drilling fluid or that becomes entrained in the drilling fluid to increase solids removal. The methods may be operated in over-pressure conditions, under-balanced conditions or under managed pressure conditions. The methods are especially well tailored to under-balanced or managed pressure conditions.

Embodiments of the present invention provide methods for drilling including the step of while drilling, circulating a first drilling fluid to provide bit lubrication, heat removal and cutting removal. Upon encountering an underground structure that produces undesirable quantities of particulate solids, changing the first drilling fluid to a second drilling fluid including aggregating compositions comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The compositions and coated fines to provide bit lubrication, heat removal and cutting removal and to alter an aggregation potential or an absolute value of a zeta potential of the particulate solids in the drilling fluid or formation or that becomes entrained in the drilling fluid to increase solids removal and to decrease particles flowing from the formation into the drilling fluid. The methods may be operated in over-pressure conditions or under-balanced conditions or under managed pressure conditions. The methods are especially well tailored to under-balanced or managed pressure conditions. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials.

Embodiments of the present invention provide methods for drilling including the step of while drilling, circulating a first drilling fluid to provide bit lubrication, heat removal and cutting removal. Upon encountering an underground structure that produces undesirable quantities of particulate solids, changing the first drilling fluid to a second drilling fluid including a composition comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The compositions and coated fines to provide bit lubrication, heat removal and cutting removal and to alter an aggregation potential or an absolute value of a zeta potential of the particulate solids in the drilling fluid or formation or that becomes entrained in the drilling fluid to increase solids removal and to decrease particles flowing from the formation into the drilling fluid. The methods may be operated in over-pressure conditions or under-balanced conditions or under managed pressure conditions. The methods are especially well tailored to under-balanced or managed pressure conditions. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non- amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials.

### Producing

Embodiments of the present invention provide methods for producing including the step of circulating and/or pumping a fluid into a well on production, where the fluid includes a composition comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The compositions and coated fines to provide bit lubrication, heat removal and cutting removal and to alter an aggregation potential or an absolute value of a zeta potential of the particulate solids in the drilling fluid or formation or that becomes entrained in the drilling fluid to increase solids removal and to decrease particles flowing from the formation into the drilling fluid. The methods may be operated in over-pressure conditions or under-balanced conditions or under managed pressure conditions. The methods are especially well tailored to under-balanced or managed pressure conditions. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials. The compositions change, alter, and/or modify aggregation potentials and/or an absolute values of zeta potentials of any particulate solids in the fluid or that becomes entrained in the fluid to increase solid particle removal and to decrease the potential of the particles to plug the formation and/or the production tubing.

Embodiments of the present invention provide methods for controlling sand or fines migration including the step of pumping a fluid including a composition comprising: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups, N-oxide groups, or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The effective is sufficient to render the compositions capable of forming partial, substantially complete, and/or complete coatings on the solid particles, surfaces and/or materials depending on the properties of the solid particles, surfaces and/or materials. The compositions and coated fines to provide bit lubrication, heat removal and cutting removal and to alter an aggregation potential or an absolute value of a zeta potential of the particulate solids in the drilling fluid or formation or that becomes entrained in the drilling fluid to increase solids removal and to decrease particles flowing from the formation into the drilling fluid. The methods may be operated in over-pressure conditions or under-balanced conditions or under managed pressure conditions. The methods are especially well tailored to under-balanced or managed pressure conditions. The oligomeric and/or polymeric amines include repeat units of ethylenically unsaturated polymerizable monomers (vinyl and diene monomers) including an amine group, a heterocyclic amine group, an aromatic amine group, substituted analogs thereof, or mixtures and combinations thereof. The oligomeric and/or polymeric amines may further include repeat units of non-amine containing ethylenically unsaturated polymerizable monomers (vinyl and diene monomers). In certain embodiments, the aggregating compositions of this invention may also include reaction products of the amines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The aggregating compositions of this invention are believed to form complete, substantially complete, and/or partial coatings on the particles, surfaces, and/or materials altering self-aggregating properties, and/or aggregation propensities of the particles, surfaces, and/or materials. The compositions change, alter, and/or modify aggregation potentials and/or an absolute values of zeta potentials of any particulate solids in the fluid or that becomes entrained in the fluid to increase solid particle removal and to decrease the potential of the particles to plug the formation and/or the production tubing.

Embodiments of the present invention provide other methods for controlling sand or fines migration including the step of depositing a coated particulate solid material of this invention adjacent screen-type sand and fines control devices so that the sand and/or fines are attracted to the coated particles and do not encounter or foul the screen of the screen-type device.

### Definitions Used in the Invention

The term “substantially” means that the property is within 80% of its desired value. In other embodiments, “substantially” means that the property is within 90% of its desired value. In other embodiments, “substantially” means that the property is within 95% of its desired value. In other embodiments, “substantially” means that the property is within 99% of its desired value. For example, the term “substantially complete” as it relates to a coating, means that the coating is at least 80% complete. In other embodiments, the term “substantially complete” as it relates to a coating, means that the coating is at least 90% complete. In other embodiments, the term “substantially complete” as it relates to a coating, means that the coating is at least 95% complete. In other embodiments, the term “substantially complete” as it relates to a coating, means that the coating is at least 99% complete.

The term “substantially” means that a value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “about” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “drilling fluids” refers to any fluid that is used during well drilling operations including oil and/or gas wells, geo-thermal wells, water wells or other similar wells.

An over-balanced drilling fluid means a drilling fluid having a circulating hydrostatic density (pressure) that is greater than the formation density (pressure).

An under-balanced and/or managed pressure drilling fluid means a drilling fluid having a circulating hydrostatic density (pressure) lower or equal to a formation density (pressure). For example, if a known formation at 10,000 ft (True Vertical Depth—TVD) has a hydrostatic pressure of 5,000 psi or 9.6 lbm/gal, an under-balanced drilling fluid would have a hydrostatic pressure less than or equal to 9.6 lbm/gal. Most under-balanced and/or managed pressure drilling fluids include at least a density reduction additive. Other additives may be included such as corrosion inhibitors, pH modifiers and/or a shale inhibitors.

The term “mole ratio” or “molar ratio” means a ratio based on relative moles of each material or compound in the ratio.

The term “weight ratio” means a ratio based on relative weight of each material or compound in the ratio.

The term “mole %” means mole percent.

The term “vol. %” means volume percent.

The term “wt. %” means weight percent.

The term “SG” means specific gravity.

The term “gpt” means gallons per thousand gallons.

The term “ppt” means pounds per thousand gallons.

The term “ppg” means pounds per gallon.

### DETAILED DESCRIPTION OF THE INVENTION

The inventors have found that new aggregation chemical compositions can be formulated using oligomers and/or polymeric comprising amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities and methods for making and using the compositions. The inventors have also found that in certain embodiments, the compositions comprise: (1) oligomeric amines (oligoamines), (2) polymeric amines (polyamines), (3) oligoamines including quaternized amine groups, N-oxide groups, or mixtures thereof, (4) polyamines including quaternized amine groups, N-oxide groups, or mixtures thereof; (5) epoxy modified amines, (6) epoxy modified oligoamines, (7) epoxy modified polyamines, (8) reaction products of epoxy containing compounds and amines, (9) reaction products of epoxy containing compounds and oligoamines, (10) reaction products of epoxy containing compounds and polyamines, (11) reaction products of epoxy containing compounds and amines, (12) reaction products of epoxy containing compounds and oligoamines, (13) reaction products of epoxy containing compounds and polyamines, (14) epoxy-amines including quaternized amine groups (R₄N⁺A⁻ groups, where A⁻ is a counterion-ammonium groups), N-oxide groups (R₃N→Ogroups), or mixtures thereof, (15) epoxy-oligoamines including quaternized amine groups, N-oxide groups, or mixtures thereof, (16) epoxy-polyamines including quaternized amine groups, N-oxide groups, or mixtures thereof, (17) reaction products of any of these materials with an acid containing compound that forms a negative charge upon deprotonation, such as, for example, acidic nitrogen containing compounds, or acidic hydroxyl containing compounds, Lewis acids, phosphate-containing compounds, or mixtures and combinations thereof, or (18) mixtures and combinations thereof. The aggregation compositions of this invention have reduced odor, while maintaining their aggregating properties, i.e., the compositions maintain their ability to alter, change, and/or modify the aggregation propensity of particles and/or surfaces treated with the compositions. Generally, it is believed that these compounds change properties of the particles and/or surfaces by forming a partial, substantially complete, or complete coating of the particles and/or surfaces, where the properties include a zeta potential of the particles and/or surfaces. Additionally, the oligoamines and/or polyamines of this invention may be prepared from pure chemical streams improving product reliability. The inventors have also found that these oligoamines and/or polyamines may be used to develop systems that are capable of agglomerating and/or aggregating inorganic mineral particles and/or surfaces that include negatively charges or positively charges, whereas the aggregating compositions using alkyl pyridines or simple polymeric amines are generally effective only for inorganic particles and/or surfaces that include negatively charges. The inventors have also found that the present compositions may also withstand and work at higher temperatures and under harsher conditions as compared to aggregating compositions that are based on alkyl pyridines or simple polymeric amines. In certain embodiments, the compositions may also include reaction products between the oligoamines and/or polyamines with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes.

The new aggregating and/or agglomerating compositions are distinct from alkylpyridine based compositions such as Weatherford SandAid or non-alkylpyridines based compositions such as Halliburton SandWedge, or polymeric amine compositions described in U.S. Pat. No. 8,466,094 and U.S. patent application Ser. No. 13/247,985. The new aggregating and/or agglomerating compositions are capable of altering, changing, and/or modifying the properties of surfaces so that the surfaces have increased aggregation properties or propensities. In fact, the new aggregating and/or agglomerating compositions are capable of reducing a zeta potential of surfaces and may be used in remedial treatment without losing the permeability of formation. Moreover, the new aggregating and/or agglomerating compositions does not have any offensive odor unlike Weatherford SandAid, or other compositions for sand control use. Furthermore, the new aggregating and/or agglomerating compositions do not include thermoset polymers, which can substantially reduce the permeability of formation and cannot be used for remedial treatment. The new aggregating and/or agglomerating compositions may also be used at higher temperatures and under much harsher conditions with improved performance.

The inventors have also found that particles, surfaces, and/or materials may be treated with the compositions of this invention, where the particles, surfaces and/or materials are coated partially or completely with the composition to form modified or coated particles, surfaces, and/or materials. The resulting modified or coated particles, surfaces and/or materials have improved aggregation tendencies and/or propensities and/or altered particle zeta potentials. The inventors have also found that the compositions, the modified metal-oxide-containing particles, surfaces and/or materials may be used in oil field applications including drilling, fracturing, producing, injecting, sand control, or any other downhole application. The inventors have also found that the modified particulate metal-oxide-containing solid particles or particles of any other solid material may be used in any other application, where increased particle aggregation potentials or where decreased absolute values of the zeta potential of the particles, which is a measure of aggregation propensity, are desirable. The inventors have also found that coated particulate metal-oxide-containing solid compositions may be formed, where the coating is deformable and the coated particles tend to self-aggregate and tend to cling to surfaces having similar coatings or having similar chemical and/or physical properties to that of the coating. That is to say, the coated particles tend to prefer like compositions, which increases their self-aggregation propensity and increases their ability to adhere to surface that have similar chemical and/or physical properties. The inventors have found that the coating compositions of this invention are distinct from known compositions for modifying particle aggregation propensities and that the coated particles are ideally suited as proppants, where the particles have altered zeta potentials that change the charge on the particles causing them to attract and agglomerate. The change in zeta potential or aggregation propensity causes each particle to have an increased frictional drag keeping the proppant in the fracture. The compositions are also ideally suited for decreasing fines migrating into a fracture pack or to decrease the adverse impact of fines migration into a fractured pack. While in certain embodiments, the present invention may include reaction products of amines and phosphate esters, the new aggregating and/or agglomerating compositions are surprisingly and unexpectedly capable of forming partial, substantially complete, and/or complete coatings on surfaces in the absence of phosphate esters that react with amines to form amine/phosphate ester reaction products. Also unexpected is the ability to tailor the oligomers and/or polymers for use on different surfaces by varying relative percentages of the amine containing repeat units, the non-amine containing groups units, the ammonium containing repeat units, and the amine oxide containing repeat units depending on the nature of the formation, zone, substrate, structure, and/or particles to be treated.

In the case of drilling, the compositions of this invention may be used to coat the formation and formation cuttings during drilling, because the particle tend to self aggregate and/or cling to similarly modified particles and/or formation surfaces. Again, an advantage of the self aggregation is a reduced tendency of the cuttings to foul or plug screens. Additional advantages are to coat the formation walls with a composition of this invention during drilling to consolidate the formation and to consolidate or aggregate fines or particles in the drilling fluid to keep the rheological properties of the drilling fluid from changing and increasing equivalent circulating density (ECD).

One problem in oil and gas production from wells is the control of the co-production of fines and sand from producing formations. Besides the co-production of particulate materials during oil and/or gas production from wells, flowback of proppant and/or fines after formation fracturing is also a problem. Additionally, it has been found that Steam Assisted Gravity Drainage (SAGD) processing of oil and/or gas wells de-stabilizes sand/fines during and after steam injection during SAGD processing.

In certain embodiments, the aggregating compositions may also include a carrier, ethoxylated alcohols, esters, and/or glymes.

Alternatively, a smaller amount of lower or higher molecular weight amine with an excess of free acidic hydroxyl containing compound or Lewis acid can be added such that enough free hydroxyl groups or Lewis acids are available to bind the positively or partially-positively charged material and bring its zeta potential close to 0.

In embodiments where the compositions of this invention include a polymeric amine or oligomeric amine or copolymeric amines or cooligomer amines or mixtures and combinations thereof are used, a polyphosphate ester component may be replaced with a simple acid such as phosphoric acid, methylene phosphonic acid, acetic acid, hydrochloric acid, nitric acid, boric acid, zinc chloride, citric acid, etc. The amount of acid added may again be varied to partially or completely neutralize any free amines present in the polymers or oligomers described previously.

In another embodiments, instead of being reacted with an acid or phosphate ester, methylene phosphonic acid, Lewis acid, the oligomeric amines, polymeric amines, co-oligomeric amines, co-polymeric amines, or mixtures and combinations thereof may be partially or completely quaternized with a variety of chemical agents such as an alkyl halide (benzyl chloride, methyl iodide, etc.), dialkyl sulfates such as dimethyl sulfate, diethyl sulfate, or other alkylating agents. Alkylation results in a more permanent positive charge that is less sensitive to formation conditions as compared to simply neutralization or quaternarization as previously described, but are still able to coat and agglomerate sand and other solid materials. Other examples of such materials include poly(diallyldimethylammonium chloride) or copolymers thereof. The quaternized material counter-ion (e,g., chloride) may also be exchanged for other counterion such as a phosphate ester through various exchange processes.

In another embodiments, an N-oxide containing oligomers, cooligomers, polymers, copolymers or mixtures and combination thereof may be formed by oxidizing the oligomeric amines, polymeric amines, cooligomeric amines,and/or copolymeric amines by oxidation using hydrogen peroxide or other oxidizing agents or by other oxidizing methods. Applicants believe that such materials would be less sensitive to formation conditions. Because N-oxides are highly polar, but have no net charge, N-oxide containing materials may be able to bind to positive and negative surfaces such as metal oxides and calcium carbonate, respectively. The previously described methods of treating the oligomeric amine or polymeric amine and/or copolymer can be used separately or combined in any manner or combination.

### Compositions

Embodiments of the present invention broadly relate to aggregating compositions comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities.

Embodiments of the present invention broadly relate to fluid compositions including a carrier and an aggregating system including oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities. In certain embodiments, the fluid compositions include reaction products of oligoamines and/or polyamines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The compositions modify surfaces of solid materials or portions thereof altering the chemical and/or physical properties of the surfaces. The altered properties permit the surfaces to become self-attracting or to permit the surfaces to be attractive to material having similar chemical and/or physical properties. In the case of particles including metal oxide particles such as particles of silica, alumina, titania, magnesia, zirconia, other metal oxides or oxides including a mixture of these metal oxides (natural or synthetic), the composition forms a complete or partial coating on the surfaces of the particles. The coating can interact with the surface by chemical and/or physical interactions including, without limitation, chemical bonds, hydrogen bonds, electrostatic interactions, dipolar interactions, hyperpolarizability interactions, cohesion, adhesion, adherence, mechanical adhesion or any other chemical and/or physical interaction that allows a coating to form on the particles. The coated particles have a greater aggregation or agglomeration propensity than the uncoated particles. Thus, the particles before treatment may be free flowing, while after coating are not free flowing, but tend to clump, aggregate and/or agglomerate. In cases, where the composition is used to coat surfaces of a geological formation, a synthetic metal oxide structure and/or metal-oxide containing particles, the particles will not only tend to aggregate together, the particles also will tend to cling to the coated formation or structural surfaces.

### Treated Structures and Substrates

Embodiments of the present invention also broadly relate to structures and substrates treated with a composition comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities. In certain embodiments, the compositions may also include a carrier. In other embodiments, the compositions include reaction products of oligoamines and/or polyamines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The compositions may also include ethoxylated alcohols, and glymes. The structures or substrates can be ceramic or metallic or fibrous. The structures or substrates can be spun such as a glass wool or steel wool or can be honeycombed like catalytic converters or the like that include channels that force fluid to flow through tortured paths so that particles in the fluid are forced in contact with the substrate or structured surfaces. Such structures or substrates are ideally suited as particulate filters or sand control media.

### Methods for Treating Particulate Solids

Embodiments of the present invention broadly relate to methods for treating metal oxide-containing surfaces including the step of contacting the metal oxide-containing surface with a composition comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities. In certain embodiments, the compositions may also include a carrier. In other embodiments, the compositions include reaction products of oligoamines and/or polyamines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The compositions are thought to form a coating on the surface altering the properties of the surface so that the surface is now capable to interacting with similarly treated surfaces to form agglomerated and/or aggregated structures. The treating may be designed to coat continuous metal oxide containing surfaces and/or the surfaces of metal oxide containing particles. If both are treated, then the particles cannot only self-aggregate, but the particles can also aggregate, agglomerate and/or cling to the coated continuous surfaces. The compositions can be used in fracturing fluids, in drilling fluids, in completion fluids, in sand control applications or any other downhole application. Additionally, the coated particles can be used in fracturing fluids. Moreover, structures, screens or filters coated with the compositions of this invention can be used to attract and remove fines that have been modified with the compositions of this invention.

Method for Fracturing and/or Propping

Embodiments of the present invention broadly relate to methods for fracturing a formation including the step of pumping a fracturing fluid including a composition comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities. In certain embodiments, the compositions may also include a carrier. In other embodiments, the compositions include reaction products of oligoamines and/or polyamines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The composition modifies an aggregation potential and/or zeta-potential of formation particles and formation surfaces during fracturing so that the formation particles aggregate and/or cling to the formation surfaces or each other increasing fracturing efficiency and increasing productivity of the fracture formation. The composition of this invention may also be used in a pre-pad step to modify the surfaces of the formation so that during fracturing the formation surfaces are pre-coated. The pre-pad step involves pumping a fluid into the formation ahead of the treatment to initiate the fracture and to expose the formation face with fluids designed to protect the formation. Beside just using the composition as part of the fracturing fluid, the fracturing fluid can also include particles that have been prior treated with the composition of this invention, where the treated particles act as proppants to prop open the formation after fracturing. If the fracturing fluid also includes the composition, then the coated particle proppant will adhere to formation surfaces to a greater degree than would uncoated particle proppant.

In an alternate embodiment of this invention, the fracturing fluid includes particles coated with a composition comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities. In certain embodiments, the compositions may also include a carrier. In other embodiments, the compositions include reaction products of oligoamines and/or polyamines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. In this embodiment, the particles have a greater self-aggregation propensity and will tend to aggregate in locations that may most need to be propped open. In all fracturing applications including proppants coated with or that become coated with the composition of this invention during fracturing, the coated proppants are likely to have improved formation penetration and adherence properties. These greater penetration and adherence or adhesion properties are due not only to a difference in the surface chemistry of the particles relative to the surface chemistry of un-treated particles, but also due to a deformability of the coating itself. Thus, the inventors believe that as the particles are being forced into the formation, the coating will deform to allow the particles to penetrate into a position and as the pressure is removed the particles will tend to remain in place due to the coating interaction with the surface and due to the relaxation of the deformed coating. In addition, the inventors believe that the altered aggregation propensity of the particles will increase proppant particle density in regions of the formation most susceptible to proppant penetration resulting in an enhance degree of formation propping.

### Method for Drilling

Embodiments of the present invention also broadly relate to methods for drilling including the step of, while drilling, circulating a drilling fluid to provide bit lubrication, heat removal and cutting removal, where the drill fluid includes a composition comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities. In certain embodiments, the compositions may also include a carrier. In other embodiments, the compositions include reaction products of oligoamines and/or polyamines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes. The compositions increase an aggregation potential or decrease an absolute value of the zeta potential of any particulate solids in the drilling fluid or that becomes entrained in the drilling fluid to increase solids removal. The compositions may also include ethoxylated alcohols, and glymes.

Embodiments of the present invention also broadly relate to methods for drilling including the step of while drilling, circulating a first drilling fluid to provide bit lubrication, heat removal and cutting removal. Upon encountering an underground structure that produces undesirable quantities of particulate solids including metal oxide-containing solids, changing the first drilling fluid for a second drilling fluid including a composition comprising heterocyclic aromatic amines, substituted heterocyclic aromatic amines, poly vinyl heterocyclic aromatic amines, co-polymers of vinyl heterocyclic aromatic amine and non-amine polymerizable monomers (ethylenically unsaturated monomers and diene monomers), or mixtures or combinations thereof in the absence of phosphate esters, methylene phosphonic acids, organic acids, mineral acids or Lewis acids to provide bit lubrication, heat removal and cutting removal and to increase an aggregation potential or decrease an absolute value of the zeta potential of any solid including particulate metal oxide-containing solids in the drilling fluid or that becomes entrained in the drilling fluid to increase solids removal. The compositions may also include ethoxylated alcohols, esters, and/or glymes.

Embodiments of the present invention also broadly relate to methods for drilling including the step of, while drilling, circulating a first drilling fluid to provide bit lubrication, heat removal and cutting removal. Upon encountering an underground structure that produces undesirable quantities of particulate solids including metal oxide-containing solids, changing the first drilling fluid for a second drilling fluid including a composition comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities to provide bit lubrication, heat removal and cutting removal and to increase an aggregation potential or zeta potential of any particulate solid including metal oxide-containing solid in the drilling fluid or that becomes entrained in the drilling fluid to increase solids removal. After passing through the structure that produces an undesired quantities of particulate metal oxide-containing solids, change the second drilling fluid for the first drilling fluid or a third drilling fluid. In certain embodiments, the compositions may also include a carrier. In other embodiments, the compositions include reaction products of oligoamines and/or polyamines of this invention with an acidic hydroxyl containing compound or a Lewis acid. In other embodiments, the fluid compositions may include ethoxylated alcohols, esters, and/or glymes.

### Method for Producing

Embodiments of the present invention also broadly relate to methods for producing including the step of circulating and/or pumping a fluid into, where the fluid includes a composition comprising oligomers and/or polymers including amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities, which increases an aggregation potential or decreases an absolute value of the zeta potential of any particulate solid including a metal oxide-containing solid in the fluid or that becomes entrained in the fluid to increase solids removal and to decrease the potential of the particles plugging the formation and/or production tubing. In certain embodiments, the compositions may also include a carrier. In other embodiments, the compositions include reaction products of oligoamines and/or polyamines of this invention with an acidic hydroxyl containing compound or a Lewis acid. In certain embodiments, the aggregating compositions may also include reaction products of polyamines having 2 to 10 amino groups and acidic hydroxyl containing compounds or Lewis acids. In other embodiments, the aggregating compositions of this invention may also include ethoxylated alcohols, esters, and/or glymes.

### Suitable Materials for Use in the Invention

Suitable oligomeric amines and polymeric amines capable of forming a deformable coating on a solid particles, surfaces, and/or materials include, without limitation, oligomers and polymers including repeat units including groups of the general formulas —NR¹R², —N⁺R¹R²R⁰A, —N⁺R¹R²O⁻, —R³, —Ar, —Hcy, or mixtures or combination of groups of these formula. In certain embodiments, the oligomers and/or polymers include (1) oligomeric amines (oligoamines) and/or polymeric amines (polyamines), (2) oligoamines and/or polyamines including an effective amount of quaternized amine groups, N-oxide groups, or mixtures of quaternized amine groups and N-oxide groups, (3) oligoethylenimines and/or polyethylenimines, (4) oligoethylenimines and/or polyethylenimines including an effective amount of quaternized amine groups, N-oxide groups, or mixtures of quaternized amine groups and N-oxide groups, (5) oligoenamines and/or polyenamines, (6) oligoenamines and/or polyenamines including an effective amount of quaternized amine groups, N-oxide groups, or mixtures of quaternized amine groups and N-oxide groups, (7) oligoimines and/or polyimines, (8) oligoimines and/or polyimines including an effective amount of quaternized amine groups, N-oxide groups, or mixtures of quaternized amine groups and N-oxide groups, (9) biooligomer and/or biopolymers including amine groups, or (10) mixtures and combinations thereof.

Biooligomers and/or Biopolymers

Suitable biooligomers and biopolymers include, without limitation, chitosans, polypeptides including at least one amino acid selected from the group consisting of lysine, tryptophan, histidine, arginine, asparagine, glutamine, and mixtures or combinations thereof, protein containing gelatins, and mixtures or combinations thereof.

### Polymerizable Amine Monomers

Suitable polymerizable amine monomers include, without limitation, vinyl amine monomers selected from the following formulas:

R^{a}R^{b}C═CR^{c}—R—NR¹R²

R^{a}R^{b}C═CR^{c}—Ar—NR¹R²

R^{a}R^{b}C═CR^{c}—R—Ar—NR¹R²

R^{a}R^{b}C═CR^{c}—Ar—R—NR¹R²

R^{a}R^{b}C═CR^{c}—R—Ar—R—NR¹R²

R^{a}R^{b}C═CR^{c}—Hcy—NR¹R²

R^{a}R^{b}C═CR^{c}—R—Hcy—NR¹R²

R^{a}R^{b}C═CR^{c}—Hcy—R—NR¹R²

R^{a}R^{b}C═CR^{c}—R—Hcy—R—NR¹R²

Other suitable polymerizable amine monomers include, without limitation, acrylate amine monomers selected from the following formulas:

R^{a}R^{b}C═CR^{c}—C(O)O—R—NR¹R²

R^{a}R^{b}C═CR^{c}—C(O)O—Ar—NR¹R²,

R^{a}R^{b}C═CR^{c}—C(O)O—R—Ar—NR¹R²

R^{a}R^{b}C═CR^{c}—C(O)O—Ar—R—NR¹R²

R^{a}R^{b}C═CR^{c}—C(O)O—R—Ar—R—NR¹R²

R^{a}R^{b}C═CR^{c}—C(O)O—Hcy—NR¹R²

R^{a}R^{b}C═CR^{c}—C(O)O—R—Hcy—NR¹R²

R^{a}R^{b}C═CR^{c}—C(O)O—Hcy—R—NR¹R²

R^{a}R^{b}C═CR^{c}—C(O)O—R—Hcy—R—NR¹R²

Other suitable polymerizable amine monomers include, without limitation, vinyl ether amine monomers selected from the following formulas:

R^{a}R^{b}C═CR^{c}—O—R—NR¹R²

R^{a}R^{b}C═CR^{c}O—Ar—NR¹R²,

R^{a}R^{b}C═CR^{c}—O—R—Ar—NR¹R²

R^{a}R^{b}C═CR^{c}—O—Ar—R—NR¹R²

R^{a}R^{b}C═CR^{c}—O—R—Ar—R—NR¹R²

R^{a}R^{b}C═CR^{c}—O—Hcy—NR¹R²

R^{a}R^{b}C═CR^{c}—O—R—Hcy—NR¹R²

R^{a}R^{b}C═CR^{c}—O—Hcy—R—NR¹R²

R^{a}R^{b}C═CR^{c}—O—R—Hcy—R—NR¹R²

### Polymerizable Ammonium Monomers

Other suitable polymerizable amine monomers include, without limitation, vinyl ammonium monomers selected from the following formulas:

R^{a}R^{b}C═CR^{c}—R—N⁺R¹R²R⁰A⁻

R^{a}R^{b}C═CR^{c}—Ar—N⁺R¹R²R⁰A⁻

R^{a}R^{b}C═CR^{c}—R—Ar—N⁺R¹R²R⁰A⁻

R^{a}R^{b}C═CR^{c}—Ar—R—N⁺R¹R²R⁰A⁻

R^{a}R^{b}C═CR^{c}—R—Ar—R—N⁺R¹R²R⁰A⁻

R^{a}R^{b}C═CR^{c}—Hcy—N⁺R¹R²R⁰A⁻

R^{a}R^{b}C═CR^{c}—R—Hcy—N⁺R¹R²R⁰A⁻

R^{a}R^{b}C═CR^{c}—Hcy—R—N⁺R¹R²R⁰A⁻

R^{a}R^{b}C═CR^{c}—R—Hcy—R—N⁺R¹R²R⁰A⁻

Other suitable polymerizable amine monomers include, without limitation, acrylate ammonium monomers selected from the following formulas:

R^{a}R^{b}C═CR^{c}—C(O)O—R—N⁺R¹R²R⁰A⁻

R^{a}R^{b}C═CR^{c}—C(O)O—Ar—N⁺R¹R²R⁰A⁻

R^{a}R^{b}C═CR^{c}—C(O)O—R—Ar—N⁺R¹R²R⁰A⁻

R^{a}R^{b}C═CR^{c}—C(O)O—Ar—R—N⁺R¹R²R⁰A⁻

R^{a}R^{b}C═CR^{c}—C(O)O—R—Ar—R′—N⁺R¹R²R⁰A⁻

R^{a}R^{b}C═CR^{c}—C(O)O—Hcy—N⁺R¹R²R⁰A⁻

R^{a}R^{b}C═CR^{c}—C(O)O—R—Hcy—N⁺R¹R²R⁰A⁻

R^{a}R^{b}C═CR^{c}—C(O)O—Hcy—R—N⁺R¹R²R⁰A⁻

R^{a}R^{b}C═CR^{c}—C(O)O—R—Hcy—R′—N⁺R¹R²R⁰A⁻

Other suitable polymerizable amine monomers include, without limitation, vinyl ether ammonium monomers selected from the following formulas:

R^{a}R^{b}C═CR^{c}—O—R—N⁺R¹R²R⁰A⁻

R^{a}R^{b}C═CR^{c}—O—Ar—N⁺R¹R²R⁰A⁻

R^{a}R^{b}C═CR^{c}—O—R—Ar—N⁺R¹R²R⁰A⁻

R^{a}R^{b}C═CR^{c}—O—Ar—R—N⁺R¹R²R⁰A⁻

R^{a}R^{b}C═CR^{c}—O—R—Ar—R′—N³⁰ R¹R²R⁰A⁻

R^{a}R^{b}C═CR^{c}—O—Hcy—N⁺R¹R²R⁰A⁻

R^{a}R^{b}C═CR^{c}—O—R—Hcy—N⁺R¹R²R⁰A⁻

R^{a}R^{b}C═CR^{c}—O—Hcy—R—N⁺R¹R²R⁰A⁻

R^{a}R^{b}C═CR^{c}—O—R—Hcy—R′—N⁺R¹R²R⁰A⁻

### Polymerizable Amine Oxide Monomers

Other suitable polymerizable amine monomers include, without limitation, vinyl amine oxide monomers selected from the following formulas:

R^{a}R^{b}C═CR^{c}—R—N⁺R¹R²O⁻

R^{a}R^{b}C═CR^{c}—Ar—N⁺R¹R²O⁻

R^{a}R^{b}C═CR^{c}—R—Ar—N⁺R¹R²O⁻

R^{a}R^{b}C═CR^{c}—Ar—R—N⁺R¹R²O⁻

R^{a}R^{b}C═CR^{c}—R—Ar—R′—N⁺R¹R²O⁻

R^{a}R^{b}C═CR^{c}—Hcy—N⁺R¹R²O⁻

R^{a}R^{b}C═CR^{c}—R—Hcy—N⁺R¹R²O⁻

R^{a}R^{b}C═CR^{c}—Hcy—R—N⁺R¹R²O⁻

R^{a}R^{b}C═CR^{c}—R—Hcy—R′—N⁺R¹R²O⁻

Other suitable polymerizable amine monomers include, without limitation, acrylate amine monomers selected from the following formulas:

R^{a}R^{b}C═CR^{c}—C(O)O—R—N⁺R¹R²O⁻

R^{a}R^{b}C═CR^{c}—C(O)O—Ar—N⁺R¹R²O⁻

R^{a}R^{b}C═CR^{c}—C(O)O—R—Ar—N⁺R¹R²O⁻

R^{a}R^{b}C═CR^{c}—C(O)O—Ar—R—N⁺R¹R²O⁻

R^{a}R^{b}C═CR^{c}—C(O)O—R—Ar—R′—N⁺R¹R²O⁻

R^{a}R^{b}C═CR^{c}—C(O)O—Hcy—N⁺R¹R²O⁻

R^{a}R^{b}C═CR^{c}—C(O)O—R—Hcy—N⁺R¹R²O⁻

R^{a}R^{b}C═CR^{c}—C(O)O—Hcy—R—N⁺R¹R²O⁻

R^{a}R^{b}C═CR^{c}—C(O)O—R—Hcy—R′—N⁺R¹R²O⁻

Other suitable polymerizable amine monomers include, without limitation, vinyl ether amine monomers selected from the following formulas:

R^{a}R^{b}C═CR^{c}—O—R—N⁺R¹R²O⁻

R^{a}R^{b}C═CR^{c}—O—Ar—N⁺R¹R²O⁻

R^{a}R^{b}C═CR^{c}—O—R—Ar—N⁺R¹R²O⁻

R^{a}R^{b}C═CR^{c}—O—Ar—R—N⁺R¹R²O⁻

R^{a}R^{b}C═CR^{c}—O—R—Ar—R′——N⁺R¹R²O⁻

R^{a}R^{b}C═CR^{c}—O—Hcy—N⁺R¹R²O⁻

R^{a}R^{b}C═CR^{c}—O—R—Hcy—N⁺R¹R²O⁻

R^{a}R^{b}C═CR^{c}—O—Hcy—R—N⁺R¹R²O⁻

R^{a}R^{b}C═CR^{c}—O—R—Hcy—R′—N⁺R¹R²O⁻

In all of the above formulas, R and R′ are independently linear or branched hydrocarbyl linking groups including from 1 to 40 carbon atoms and the required hydrogen atoms to satisfy the valencies, where one or more of the carbon atoms may be replaced by one or more hetero atoms selected from the group consisting of boron, nitrogen, oxygen, phosphorus, sulfur or mixture and combinations thereof and where one or more of the hydrogen atoms may be replaced by one or more single valence atoms selected from the group consisting of fluorine, chlorine, bromine, iodine or mixtures or combinations thereof. Thus, R and R′ may be polymethyleneoxide, polyethyleneoxide, polypropyleneoxide, or higher polyalkylenesoxide groups. R^{a}, R^{b}, and R^{c} are independently linear or branched hydrocarbyl groups including from 1 to 40 carbon atoms and the required hydrogen atoms to satisfy the valencies, where one or more of the carbon atoms may be replaced by one or more hetero atoms selected from the group consisting of boron, nitrogen, oxygen, phosphorus, sulfur or mixture and combinations thereof and where one or more of the hydrogen atoms may be replaced by one or more single valence atoms selected from the group consisting of fluorine, chlorine, bromine, iodine or mixtures or combinations thereof. R¹, R², and R³ are independently linear or branched hydrocarbyl groups including from 1 to 40 carbon atoms and the required hydrogen atoms to satisfy the valencies, where one or more of the carbon atoms may be replaced by one or more hetero atoms selected from the group consisting of boron, nitrogen, oxygen, phosphorus, sulfur or mixture and combinations thereof and where one or more of the hydrogen atoms may be replaced by one or more single valence atoms selected from the group consisting of fluorine, chlorine, bromine, iodine or mixtures or combinations thereof. Ar is an aryl group including from 6 to 40 carbon atoms and the required hydrogen atoms to satisfy the valencies, where one or more of the carbon atoms may be replaced by one or more hetero atoms selected from the group consisting of boron, nitrogen, oxygen, phosphorus, sulfur or mixture and combinations thereof and where one or more of the hydrogen atoms may be replaced by one or more single valence atoms selected from the group consisting of fluorine, chlorine, bromine, iodine or mixtures or combinations thereof. Hcy is a heterocyclic group including from 4 to 40 carbon atoms and the required hydrogen atoms to satisfy the valencies and one more hetero atoms selected from the group consisting of oxygen atoms, nitrogen atoms, and sulfur atoms, where one or more of the hydrogen atoms may be replaced by one or more single valence atoms selected from the group consisting of fluorine, chlorine, bromine, iodine or mixtures or combinations thereof. A and R⁰ are derived from the general formula R⁰A selected from the formulas consisting of R^{I}R^{II}SO₄, R^{I}SO₃H, R^{I}R^{II}PO₄, R^{I}PO₃H, R^{III}X, ArCl, ArR^{IV}X, R^{V}O(R^{VI}O)R^{VI}X, XR^{VI}O(R^{VI}O)R^{VI}X, or mixtures and combinations thereof, where R^{I}, R^{II}, R^{III}, and R^{V} are the same or different hydrocarbyl groups, Ar is an aryl group, and R^{IV} and R^{VI} are the same or different linking hydrocarbyl groups and X is a halogen atom including F, Cl, Br, and I, where R⁰ is selected from the group consisting of a hydrogen atom (H), R^{I} or R^{II}, R^{III}, Ar, ArR^{IV}, R^{V}O(R^{VI}O)R^{VII}, XR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, R^{I}PO₄⁻ or R^{II}PO₄⁻, R^{I}PO₃⁻, X⁻, [R^{VI}O(R^{VI}O)R^{VI}X]⁻, [R^{VI}O(R^{VI}O)R^{VI}]²⁻, and mixtures thereof.

Of course, the ammonium and amine oxide groups do not have to be added to an oligomer or a polymer via polymerization of the above listed polymerizable monomers, but the ammonium groups and amine oxide groups may be formed after oligomer or polymer formation. In the case of ammonium groups, oligomers and/or polymers including amine groups may be reacted with R⁰A groups to form ammonium groups from amine groups in the oligomers and/or polymers. The degree of conversion of the amine groups to ammonium groups may be from 0.1% to substantially 100% or to 100% depending on the application. In the case of amine oxide groups, oligomers and/or polymers including amine groups may be reacted with oxidizing agents under conditions to convert amines into amine oxides. Again, the degree of conversion may be from 0.1% to substantially 100% or to 100% depending on the application.

In certain embodiments, vinyl heterocyclic amines include, without limitation, vinyl pyridine, vinyl substituted pyridine, vinyl pyrrole, vinyl substituted pyrroles, vinyl piperidine, vinyl substituted piperidines, vinyl pyrrolidine, vinyl substituted pyrrolidines, vinyl indole, vinyl substituted indoles,vinyl imidazole, vinyl substituted imidazole, vinyl quinoline, vinyl substituted quinoline, vinyl isoquinoline, vinyl substituted isoquinoline, vinyl pyrazine, vinyl substituted pyrazine, vinyl quinoxaline, vinyl substituted quinoxaline, vinyl acridine, vinyl substituted acridine, vinyl pyrimidine, vinyl substituted pyrimidine, vinyl quinazoline, vinyl substituted quinazoline, or mixtures and combinations thereof. Exemplary examples include, without limitation, poly-2-vinyl pyridine, poly-4-vinyl pyridine, and mixtures or combinations thereof and copolymers selected from the group consisting of copolymers of 2-vinyl pyridine and 4-vinyl pyridine, copolymers of ethylene and 2-vinyl pyridine and/or 4-vinyl pyridine, copolymers of propylene and 2-vinyl pyridine and/or 4-vinyl pyridine, copolymers of acrylic acid and 2-vinyl pyridine and/or 4-vinyl pyridine, copolymers of methacrylic acid and 2-vinyl pyridine and/or 4-vinyl pyridine, copolymers of acrylates and 2-vinyl pyridine and/or 4-vinyl pyridine, copolymers of methacrylates and 2-vinyl pyridine and/or 4-vinyl pyridine, and mixtures or combinations thereof and optionally a reaction product of an amine and an acidic hydroxyl containing compound or Lewis acid. Other polymers include, without limitation, any polymer including repeat units derived from a heterocyclic or heterocyclic aromatic vinyl monomer, where the hetero atoms is a nitrogen atom or a combination of a nitrogen atom and another hetero atoms selected from the group consisting of boron, oxygen, phosphorus, sulfur, germanium, and/or mixtures thereof. The polymers can be homopolymers of cyclic or aromatic nitrogen-containing vinyl monomers, or copolymers of any ethylenically unsaturated monomers that will copolymerize with a cyclic or aromatic nitrogen-containing vinyl monomer. Exemplary cyclic or aromatic nitrogen-containing vinyl monomers include, without limitation, vinyl pyrroles, substituted vinyl pyrroles, vinyl pyridines, substituted vinyl pyridines, vinyl quinolines or substituted vinyl quinolines, vinyl anilines or substituted vinyl anilines, vinyl piperidines or substituted vinyl piperidines, vinyl pyrrolidines or substituted vinyl pyrrolidines, vinyl imidazole or substituted vinyl imidazole, vinyl pyrazine or substituted vinyl pyrazines, vinyl pyrimidine or substituted vinyl pyrimidine, vinyl quinazoline or substituted vinyl quinazoline, or mixtures or combinations thereof. Examples of co-monomers for vinyl polymers: styrene, acrylamides, acrylates, methacrylate, etc.

The oligomers and/or polymers of this invention generally have a weight average molecular weight of between about 500 and 1,000,000. In other embodiments, the weight average molecular weight of between about 1,000 and 1,000,000. In other embodiments, the weight average molecular weight of between about 5,000 and 1,000,000. In other embodiments, the weight average molecular weight of between about 10,000 and 1,000,000. In certain embodiments, the weight average molecular weight of between about 500 and 500,000. In other embodiments, the weight average molecular weight of between about 1,000 and 500,000. In other embodiments, the weight average molecular weight of between about 5,000 and 500,000. In other embodiments, the weight average molecular weight of between about 10,000 and 500,000. In other embodiments, the weight average molecular weight of between about 500 and 250,000. In other embodiments, the weight average molecular weight of between about 1,000 and 250,000. In other embodiments, the weight average molecular weight of between about 5,000 and 250,000. In other embodiments, the weight average molecular weight of between about 10,000 and 250,000. In other embodiments, the weight average molecular weight of between about 500 and 100,000. In other embodiments, the weight average molecular weight of between about 1,000 and 100,000. In other embodiments, the weight average molecular weight of between about 5,000 and 100,000. In other embodiments, the weight average molecular weight of between about 10,000 and 100,000. In all case, the weight average molecular weights and nature of the monomer make up of the oligomers and/or polymers of this invention are tailored to specific surfaces that compositions is to treat.

This invention involves different systems for changing, altering, and/or modifying a zeta potential formation surfaces and particle surfaces to change their aggregation and agglomeration propensities. The present compositions are well suited for use in remedial treatment to coat frac-pack sand or gravel-pack sand to prevent sand production by agglomeration. Coating of sand or other metal-oxide surfaces with treating compositions of this invention leads to a decrease in the absolute value of the surface zeta potentials to a value at or near zero (generally, to a value of 0±100 millivolts) and an increase the propensity of particles to aggregate and/or agglomerate with each other or for particles to adhere to surfaces. To our knowledge, no system disclosed or taught compositions amine containing repeat units, non-amine containing groups units, ammonium containing repeat units, amine oxide containing repeat units, or mixtures and combinations thereof, where relative percentages of the amine containing repeat units, the non-amine containing groups units, the ammonium containing repeat units, and the amine oxide containing repeat units are tailored to the exact requirements of the formation, zone, particles and/or structure to be treated and where the composition forms partial, substantially complete, and/or complete coatings on the particles, surfaces and/or materials altering their self-aggregating properties and/or aggregation propensities.

The molecular weight and degree of co-polymerization with hydrophobic or hydrophilic moieties can tailor the properties of the material to have the proper oil and water solubility as well as affect the substrate zeta potential. For instance, a material with both hydrophilic and hydrophobic components may have limited solubility in both oil and water and thus remain on the substrate and lead to efficient sand control for a longer period of time. The molecular weight of the amine can be tailored to a particular application. For instance, oligomeric material may be used in tight formations to limit formation damage while polymeric material may be used in less tight formations or for frac-pack or gravel-pack applications.

In addition, the monomeric or oligomeric phosphate ester can be extended to include any polymer containing phosphate groups including organic and inorganic polyphosphates including cyclic and linear phosphates. Importantly, amine-based formulations are generally more effective on metal oxide materials such as sand (silicon dioxide) with a negative or partially negative charge compared to on calcium carbonate (limestone) or other positively or partially positively charged materials. However, it is possible to use the polymeric phosphates without the amine component to more effectively bind and agglomerate the positively charged material.

### Epoxy Compounds 3 and α

Suitable epoxy compound for reacting with amines to form epoxy modified amines, epoxy modified amine oligomers, and/or epoxy modified amine polymers include without limitation, any epoxy compound that is capable of reacting with primary, secondary, heterocyclic amines, and/or tertiary amines. Exemplary examples include epoxy compound of the general formulas:

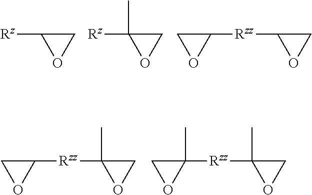

where R^{z} is a hydrocarbyl group having between about 1 and about 20 carbon atoms, where one or more of the carbon atoms may be replaced by oxygen atoms and where Rzz is a linking group selected from the group consisting of linear, branched, and/or cyclic hydrocarbyl linking groups, aromatic linking groups, alkaryl linking groups, arylalkyl linking groups having from 1 to 40 carbon atom, where one or more of the carbon atoms may replace by oxygen atoms or mixtures and combinations thereof. Exemplary examples of epoxy compounds having two epoxy group include, without limitation, epoxy compounds of the following formulas:

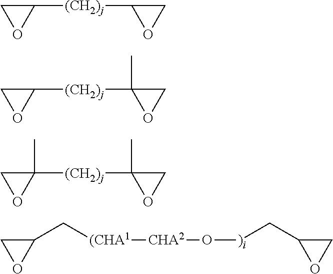

where j is an integer having a value between 1 and about 20 carbon atoms, where one or more carbon atoms are oxygen atoms and i is integer having a value between about 1 and about 20 carbon atoms, where one or more carbon atoms may be replaced by oxygen atoms or mixtures and combinations thereof. Exemplary example of specific epoxy compounds having two epoxy group include, without limitation, epoxy compounds of the following formulas:

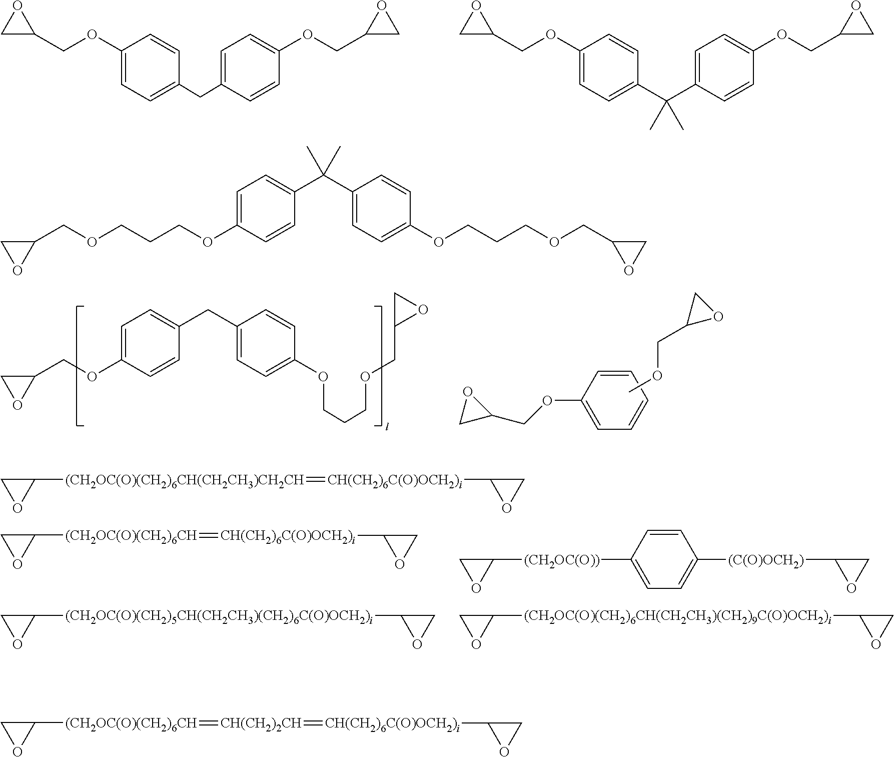

or mixtures and combinations thereof, where l is an integer having a value between 1 and about 100. Exemplary example of specific epoxy compounds having a plurality of epoxy groups include, without limitation, epoxy compounds of the following formulas:

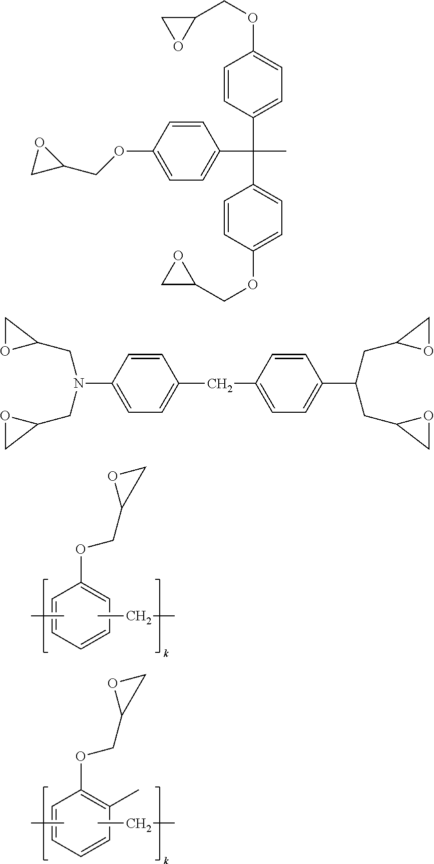

or mixtures and combinations thereof, where k is an integer having a value between about 10 to about 100,00 and where the polymeric epoxy compound may include non epoxy containing repeat units.

### Phosphate Containing Compounds

Suitable phosphate compounds capable of reacting with amines to form deformable coating on solid materials include, without limitation, any phosphate compound or any phosphate ester or methylene phosphonic acid that are capable of reacting with a suitable amine to form a reaction product capable of forming a deformable coating on a surface or particulate materials. Exemplary examples of such phosphate esters include, without limitation, phosphoric acid, polyphosphoric acid, and phosphate esters of the general formula P(O)(OR⁴)(OR⁵)(OR⁶)or mixture or combinations thereof, where R⁴, R⁵, and R⁶ are independently a hydrogen atom or a hydrocarbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Exemplary examples of phosphate esters include, without limitation, phosphate ester of alkanols having the general formula P(O)(OH)ₓ(OR⁷)_{y} where x+y=3 and R⁷ are independently a hydrogen atom or a hydrocarbyl group having between about between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof such as ethoxy phosphate, propoxyl phosphate, phosphate esters of polyoxyethylated decanol, 2-tridecoxyethyl phosphate, phosphoric acid, decyloctylester or higher alkoxy phosphates or mixtures or combinations thereof. Other exemplary examples of phosphate esters include, without limitation, phosphate esters of alkanol amines having the general formula N[R⁸OP(O)(OH)₂]₃ where R⁸ are independently are independently linking groups sometime referred to as hydrocarbenyl groups (meaning that the groups are bonded to two different groups such as methylene —CH₂—, ethylene —CH₂CH₂—, etc) having between about between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof group including the tri-phosphate ester of tri-ethanol amine or mixtures or combinations thereof. Other exemplary examples of phosphate esters include, without limitation, phosphate esters of hydroxylated aromatics such as phosphate esters of alkylated phenols such as nonylphenyl phosphate ester or phenolic phosphate esters. Other exemplary examples of phosphate esters include, without limitation, phosphate esters of diols and polyols such as phosphate esters of ethylene glycol, propylene glycol, or higher glycolic structures. Other exemplary phosphate esters include any phosphate ester than can react with an amine and coated on to a substrate forms a deformable coating enhancing the aggregating potential of the substrate. Examples of methylene phosphonic acids include methylene phosphonic acids such as aminoethylethanolamine tris(methylene phosphonic acid), diethylenetriamine tetra(methylene phosphonic acid), diethylenetriamine penta(methylene phosphonic acid), bis(hexamethylene triamino penta(methylenephosphonic acid) and the like.

In addition, the monomelic or oligomeric phosphate ester can be extended to include any polymer containing phosphate groups including organic and inorganic polyphosphates including cyclic and linear phosphates. Importantly, amine-based formulations are generally more effective on metal oxide materials such as sand (silicon dioxide) with a negative or partially negative charge compared to on calcium carbonate (limestone) or other positively or partially positively charged materials. In certain embodiments, polymeric phosphates without an amine component may be used effectively bind and agglomerate positively charged materials. Some amine may also be present (to bring down water solubility for instance), but the phosphate groups would have to be in excess so the molecules have a net negative charge to bind to positively charged surfaces. Also, we believe that N-oxides groups may be used to agglomerate any type of surface, because they have a polar rather than a true charged nature that could be attracted to either positively or negatively charged surfaces.

### Methylene Phosphonic Acids

Exemplary examples of such methylene phosphonic acids include, without limitation, any methylene phosphonic acids of the general formula:

R⁹R¹⁰N—CH₂—P(O)(OH)₂

or mixture or combinations thereof, oligomeric and/or polymeric derivatives thereof, where the R⁹ and R¹⁰ groups are independently a hydrogen atom or a hydrocarbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Suitable methylene phosphonic acids capable of reacting with amines to form deformable coating on solid materials include, without limitation, are aminoethylethanolamine tris(methylene phosphonic acid); diethylene triamine penta (methylene phosphonic acid); bis(hexmethylenetriamino penta(methylenephosphonic acid) and the like.

### Amines

Suitable amines include, without limitation, any amine that is capable of reacting with a suitable acidic hydroxyl containing compounds or Lewis acids such as phosphate esters to form a composition that forms a deformable coating on a metal-oxide containing surface. Exemplary examples of such amines include, without limitation, any amine of the general formula R¹R²NH, R¹R²R³N, or mixtures or combinations thereof, where R¹, R² and R³ are independently a hydrogen atom or a hydrocarbyl group having between about between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Exemplary examples of amines suitable for use in this invention include, without limitation, aniline and alkyl anilines or mixtures of alkyl anilines, pyridines and alkyl pyridines or mixtures of alkyl pyridines, pyrrole and alkyl pyrroles or mixtures of alkyl pyrroles, piperidine and alkyl piperidines or mixtures of alkyl piperidines, pyrrolidine and alkyl pyrrolidines or mixtures of alkyl pyrrolidines, indole and alkyl indoles or mixture of alkyl indoles, imidazole and alkyl imidazole or mixtures of alkyl imidazole, quinoline and alkyl quinoline or mixture of alkyl quinoline, isoquinoline and alkyl isoquinoline or mixture of alkyl isoquinoline, pyrazine and alkyl pyrazine or mixture of alkyl pyrazine, quinoxaline and alkyl quinoxaline or mixture of alkyl quinoxaline, acridine and alkyl acridine or mixture of alkyl acridine, pyrimidine and alkyl pyrimidine or mixture of alkyl pyrimidine, quinazoline and alkyl quinazoline or mixture of alkyl quinazoline, or mixtures or combinations thereof.

Suitable amines capable of forming a deformable coating on a solid particles, surfaces, and/or materials include, without limitation, heterocyclic aromatic amines, substituted heterocyclic aromatic amines, or mixtures or combinations thereof, where the substituents of the substituted heterocyclic aromatic amines are hydrocarbyl groups having between about between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. In certain embodiments, amines suitable for use in this invention include, without limitation, aniline and alkyl anilines or mixtures of alkyl anilines, pyridines and alkyl pyridines or mixtures of alkyl pyridines, pyrrole and alkyl pyrroles or mixtures of alkyl pyrroles, piperidine and alkyl piperidines or mixtures of alkyl piperidines, pyrrolidine and alkyl pyrrolidines or mixtures of alkyl pyrrolidines, indole and alkyl indoles or mixture of alkyl indoles, imidazole and alkyl imidazole or mixtures of alkyl imidazole, quinoline and alkyl quinoline or mixture of alkyl quinoline, isoquinoline and alkyl isoquinoline or mixture of alkyl isoquinoline, pyrazine and alkyl pyrazine or mixture of alkyl pyrazine, quinoxaline and alkyl quinoxaline or mixture of alkyl quinoxaline, acridine and alkyl acridine or mixture of alkyl acridine, pyrimidine and alkyl pyrimidine or mixture of alkyl pyrimidine, quinazoline and alkyl quinazoline or mixture of alkyl quinazoline, or mixtures or combinations thereof.

### Acidic Hydroxyl Compounds

Suitable acidic hydroxyl compounds capable of reacting with amines to form deformable coating on solid materials include, without limitation, a mineral acid, an organic acid, or mixtures and combinations thereof. Exemplary examples of minerals acids include phosphoric acid, sulfur acid, hydrochloric acid, hydrobromic acid, nitric acid, boric acid, or mixtures and combinations thereof. Exemplary organic acids include, without limitation, monocarboxylic acids, dicarboxylic acids, polymeric carboxylic acids, and mixtures or combinations thereof, where the carboxylic acids include from about 1 to about 40 carbon atoms. Exemplary examples of monocarboxylic acids include formic acid, acetic acid, lactic acid, citric acid, succinic acid, maleic acid, adipic acid, tricarballylic acid, Westvaco Diacid 1550, or mixtures and combinations thereof. Exemplary Lewis acids are zinc chloride, titanium (IV) chloride, tin (IV) chloride, aluminum bromide, aluminum chloride, boron trichloride and boron trifluoride. In certain embodiments, the oligomeric amines and/or polymeric amines may be reacted with a combination of phosphate compounds and non-phosphate compounds as the reaction products may include phosphate compound-oligomeric amines and/or polymeric amines reactions products and non-phosphate compound-oligomeric amines and/or polymeric amines reactions products.

### Lewis Acid Compounds

Suitable Lewis acid compounds capable of reacting with amines to form deformable coating on solid materials include, without limitation, includes, without limitation, metal compounds capable of reaction with the amines, polyamines, polymeric amines, or mixtures and combinations thereof to form a deformable coating on solid materials. The metal compounds are selected from the group consisting of groups 2-17 metal compounds. The group 2 metal compounds include compounds of Be, Mg, Ca, Sr, and Ba. The group 3 metal compounds include compounds of Sc, Y, La and Ac. The group 4 metal compounds include compounds of Ti, Zr, Hf, Ce, and Th. The group 5metal compounds include compounds of V, Nb, Ta, and Pr. The group 6 metal compounds include compounds of Cr, Mo, W, Nd, and U. The group 7 metal compounds include compounds of Mn, Tc, Re, and Pm. The group 8 metal compounds include compounds of Fe, Ru, Os, and Sm. The group 9 metal compounds include compounds of Co, Rh, Ir, and Eu. The group 10 metal compounds include compounds of Ni, Pd, Pt, and Gd. The group 11 metal compounds include compounds of Cu, Ag, Au, and Tb. The group 12 metal compounds include compounds of Zn, Cd, Hg, and Dy. The group 13 metal compounds include compounds of Al, Ga, In, Tl, and Ho. The group 14 metal compounds include compounds of Si, Ge, Sn, Pb, and Er. The group 15 metal compounds include compounds of As, Sb, Bi, and Tm. The group 16 metal compounds include compounds of Yb. The group 17 metal compounds include compounds of Lu. Alternatively, the metal compounds includes alkaline earth metal compounds, poor metal compounds, transition metal compounds, lanthanide metal compounds, actinide metal compounds, and mixtures or combinations thereof. The metal compounds may be in the form of halides, oxyhalides, tetrahaloboranes (e.g., BF₄⁻), carbonates, oxides, sulfates, hydrogensulfates, sulfites, hydrosulfites, hexahalophosphates, phosphates, hydrogenphosphates, phosphites, hydrogenphosphites, nitrates, nitrites, carboxylates (e.g., formates, acetates, propionates, butionates, citrates, oxylates, or higher carboxylates), hydroxides, any other counterion, and mixtures or combinations thereof.

### Crosslinking Agents

Suitable organic crosslinking agents include, without limitation, poly-glycidyl ethers, such as, for example, di-glycidyl ethers and tri-glycidyl ethers or other higher poly-glycidyl ethers; hydrocarbyldihalides; bisphenol A; polyisocyanates, such as, for example, di-isocyanates and tri-isocyanates or other higher polyisocyanates; diacyl azides; cyanuaric chloride; diacids; polyacids; imidylated di and poly carboxylic acids; anhydrides; carbonates; polyepoxides, such as, for example, diepoxides or other higher polyepoxides; polyaldehydes, such as, for example, dialdehydes or other higher polyaldehydes; polyisothioisocyanates, such as, for example, diisothiocyanates or other higher polyisothioisocyanates; polyvinylsulfones, such as, for example, divinylsulfones or other higher polyvinyl sulfones; silanes; and other similar organic crosslinking agents, or mixtures or combinations thereof.

Suitable silane crosslinking compounds, especially alkoxy silane compounds, may be used to crosslink compounds including hydroxyl groups, especially hydroxyl groups resulting from the reaction product of amines with amine reactive compounds such as organic acids, anhydrides, phosphate esters, or methylene phosphonic acid generating silanol groups that are available to react with silanol group on solid materials. Thus, these silane compound not only crosslink the aggregating compositions of this invention, but may also assist in anchoring the aggregating compositions of this invention to solid materials. Exemplary examples of silane crosslinking compound include, without limitation, triacetoxyethylsilane, 1,2-bis(triethyoxysilyl)ethan, 3-methacryloxy propyl trimethoxy silane, methacryloxy methyl trimethoxysilane, 3-isocyanato propyl trimethoxy silane, glycidoxy propyl triethoxy silane manufactured by Wacker Chemie AG in Munchen, German; p-styryl trimethoxy silane, vinyl trimethoxy silane, bis(triethoxysilylpropyl)tetrasulfide, KBE-9007, KBM-9659 and X-12-967C manufactured by Shin-Etsu in Tokyo, Japan, other silanes, or mixtures and combinations thereof. The crosslinking agents could be used to increase the agglomeration strength of the composition, or lead to consolidation/development of compressive strength.

### Resins

The compositions disclosed herein can also include resins. Resins suitable for use in the compositions and methods hereing can include all resins known in the art that are capable of forming a hardened, consolidated mass. Many suitable resins are commonly used in subterranean consolidation operations, and some suitable resins include two component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, cyanate esters, polyurethane resins and hybrids and copolymers thereof, acrylate resins, and mixtures thereof.

Some suitable resins, such as epoxy resins, may be cured with an internal catalyst or activator so that when pumped down hole, they may be cured using only time and temperature. Other suitable resins, such as furan resins generally require a time-delayed catalyst or an external catalyst to help activate the polymerization of the resins if the cure temperature is low (i.e., less than 250° F.), but will cure under the effect of time and temperature if the formation temperature is above about 250° F., preferably above about 300° F. An epoxy resin may be preferred when using the methods of the present invention in formations having temperatures ranging from about 65° F. to about 350° F. and a furan resin may be preferred when using the methods of the present invention in formations having temperatures above about 300° F.

It is within the ability of one skilled in the art, with the benefit of this disclosure, to select a suitable resin for use in embodiments of the compositions and methods herein, and to determine whether a catalyst is required to trigger curing. As with the crosslinking agents, the resins and resin/catalyst blends could be used to increase the agglomeration strength of the composition, or lead to consolidation/development of compressive strength.

### Hydrophobic Agents

Hydrophobic agents can be reacted with the amine or polyamine to form deformable coating on solid materials. Suitable hydrophobic agents are organic halides such a 1-bromohexadecane, 1-chlorohexadecane, 1-bromotetradecane, 1-bromododecane, 1-bromooctane and the like.

### Tackifying Compounds

Suitable tackifying compounds and process are disclosed in U.S. Pat. No. 5,853,048; 7,258,170 B2 and U.S. 2005/0277554 A1. Tackifying compositions or bonding agents include polyacrylate ester polymers, polyamide, phenolic and epoxy. Tackifying compounds may be produced by the reaction of a polyacid with a multivalent ion such as calcium, aluminum, iron or the like. Similarly various polyorganophosphates, polyphosphonate, polysulfate, polycarboxylates or polysilicates may be reacted with a multivalent ion to yield a tackifying compound. In certain embodiment, the tackifying agent is the condensation reaction of polyacids and polyamines. C36 dibasic acids, trimer acids, synthetic acids produced from fatty acids, maleic anhydride and acrylic acids are examples of polyacids. Polyamines can comprise ethylenediamine, diethylentriamine, triethylenetetramine, tetraethylenepentamine, N-(2-aminoethyl)piperazine and the like.

### Glymes

Suitable glymes including, without limitation, diethylene glycol dimethyl ether, ethylene-propylene glycol dimethyl ether, dipropylene glycol dimethyl ether, diethylene glycol diethyl ether, ethylene, propylene glycol diethyl ether, dipropylene glycol diethyl ether, glycol ether EB (2-butoxyethnol), dipropylene glycol methyl ether or mixture or combinations thereof. In certain embodiments, the glyme is dipropylene glycol dimethyl ether sold as Proglyme from Novolyte Technologies of Independence, OH. Dipropylene glycol methyl ether is sold as Dowanol DPM by Dow Chemical Company.

### Esters

Suitable esters include, without limitation, esters of monocarboxylic acids of formula R^{d}COOR^{e}, esters of dicarboxylic acids of formula R^{e}OOC—R^{ff}—COOR^{e}, esters of polycarboxylic acid of the formula R^{gg}—(COOR^{e})ₙ, and mixtures or combinations thereof. In the formulas, R^{d} and R^{e} are independently hydrocarbyl groups (linear, branched, saturated, unsaturated, aryl, alkaaryl, arylalkyl, or mixtures and combination thereof) having between 1 and 20 carbon atoms, one or more of the carbon atoms may be replaced by oxygen atoms and R^{ff} are independently linking hydrocarbyl groups including two or more linking bonds and having between 3 and 20 carbon atoms, one or more of the carbon atoms may be replaced by oxygen atoms and R^{gg} is a group having n attachment sites, where n is an integer having a value between about 3 and 1,000. Exemplary examples of ester include di dimethyl R-2-methyl glutarate available from Rhodia as Rhodiasolv Iris.

### Alkylpyridines

Suitable alkylpyridines include, without limitation, 2-monohydrocarbylpyridine, 3-monohydrocarbyl pyridine, 4-monohydrocarbyl pyridine, 2,3-dihydrocarbylpyridine, 2,4-dihydrocarbylpyridine, 2,5-dihydrocarbylpyridine, 2,6-dihydrocarbylpyridine, 3,4-dihydrocarbylpyridine, 3,5-dihydrocarbylpyridine, trihydrocarbylpyridines, tetrahydrocarbylpyridines, pentahydrocarbylpyridines, and mixtures or combinations thereof, where the hydrocarbyl groups may be linear, branched, saturated, unsaturated, aryl, alkaaryl, arylalkyl, or mixtures and combination thereof having between 1 and 20 carbon atoms, one or more carbon atoms may be replace by oxygen atoms. Alkylpyridines are suitable solvents for polyvinylpyridines. Exemplary examples of alkylpyridines include PAP-220 available from Vertellus Specialties Inc.

### Carriers

Suitable carriers for use in the present invention include, without limitation, low molecular weight alcohols having between 1 and 5 carbon atoms, where one or more of the carbon atoms may be oxygen or mixtures or combinations thereof. Exemplary examples include methanol, ethanol, propanaol, isopropyl alcohol, butanol, isobutanol, pentanol, isopentanol, neopentanolm, ethylene glycol, or mixture or combinations thereof.

### Ethoxylated Alcohols

Suitable ethoxylated alcohols include, without limitation, any ethoxylated alcohol having an HLB value between about 6 and 10 or mixtures or combinations thereof. In other, embodiments, the ethoxylated alcohol having an HLB value between about 7 and 9 or mixtures or combinations thereof. In other embodiments, ethoxylated alcohol having an HLB value between about 7.5 and 8.5 or mixtures or combinations thereof. In other embodiments, ethoxylated alcohol having an HLB value between about 8 or mixtures or combinations thereof. Exemplary ethoxylated alcohols include, without limitation, C6-C₁₈ alcohols, linear or branched, and 2 to 6 ethoxylations (2 to 6 ethyleneoxide units) per alcohol or mixtures or combinations thereof. In certain embodiments, the ethoxylated alcohols include C₆₋C₁₄ alcohols, linear or branched with 2 to 5 ethoxylations (2 to 5 ethyleneoxide units) per alcohol or mixtures or combinations thereof. In certain embodiments, the ethoxylated alcohol include C₆ alcohols, linear or branched with 2 to 5 ethoxylations (2 to 5 ethyleneoxide units) per alcohol or mixtures or combinations thereof. In certain embodiments, the ethoxylated alcohols include C₁₂ alcohols, linear or branched with 2 to 5 ethoxylations (2 to 5 ethyleneoxide units) per alcohol or mixtures or combinations thereof. In certain embodiments, the ethoxylated alcohols include C₁₃ alcohols, linear or branched with 2 to 5 ethoxylations (2 to 5 ethyleneoxide units) per alcohol. In certain embodiments, the ethoxylated alcohols include C₁₄ alcohols, linear or branched with 2 to 5 ethoxylations (2 to ethyleneoxide units) per alcohol or mixtures or combinations thereof. In certain embodiment, the ethoxylated alcohol os an ethoxylated hexyl alcohol such as Novel 6-3 Ethoxylate. Novel 6-3 Ethoxylate is available from SASOL North Americas, Inc. In another embodiments, the ethoxylated alcohol is an ethoxylated iso-tridecyl alcohol such as ALFONIC® TDA-3 available for Sasol North Americas, Inc

### Solid Materials

Suitable solid materials suitable for being coated with the compositions of this invention include, without limitation, metal oxides and/or ceramics, natural or synthetic, metals, plastics and/or other polymeric solids, solid materials derived from plants, or any other solid material that does or may find use in downhole applications or mixtures or combinations thereof. Metal oxides including any solid oxide of a metallic element of the periodic table of elements. Exemplary examples of metal oxides and ceramics include actinium oxides, aluminum oxides, antimony oxides, boron oxides, barium oxides, bismuth oxides, calcium oxides, cerium oxides, cobalt oxides, chromium oxides, cesium oxides, copper oxides, dysprosium oxides, erbium oxides, europium oxides, gallium oxides, germanium oxides, iridium oxides, iron oxides, lanthanum oxides, lithium oxides, magnesium oxides, manganese oxides, molybdenum oxides, niobium oxides, neodymium oxides, nickel oxides, osmium oxides, palladium oxides, potassium oxides, promethium oxides, praseodymium oxides, platinum oxides, rubidium oxides, rhenium oxides, rhodium oxides, ruthenium oxides, scandium oxides, selenium oxides, silicon oxides, samarium oxides, silver oxides, sodium oxides, strontium oxides, tantalum oxides, terbium oxides, tellurium oxides, thorium oxides, tin oxides, titanium oxides, thallium oxides, thulium oxides, vanadium oxides, tungsten oxides, yttrium oxides, ytterbium oxides, zinc oxides, zirconium oxides, ceramic structures prepared from one or more of these oxides and mixed metal oxides including two or more of the above listed metal oxides. Exemplary examples of plant materials include, without limitation, shells of seed bearing plants such as walnut shells, pecan shells, peanut shells, shells for other hard shelled seed forming plants, ground wood or other fibrous cellulosic materials, or mixtures or combinations thereof.

### Compositional Ranges and Properties

Embodiments of the aggregating compositions of this invention include:

from about 5 wt. % to about 95 wt. % of oligoamines and/or polyamines of this invention.

In certain embodiments of the aggregating compositions of this invention include:

from about 10 wt. % to about 90 wt. % of oligoamines and/or polyamines of this invention.

In other embodiments of the aggregating compositions of this invention include:

from about 20 wt. % to about 80 wt. % of oligoamines and/or polyamines of this invention.

In other embodiments of the aggregating compositions of this invention include:

from about 30 wt. % to about 70 wt. % of oligoamines and/or polyamines of this invention.

In other embodiments of the aggregating compositions of this invention include:

from about 40 wt. % to about 60 wt. % of oligoamines and/or polyamines of this invention.

In other embodiments of the aggregating compositions of this invention further include:

from about 5 wt. % to about 50 wt. % of a carrier,

where the weight percent may add to greater than 100 weight percent.

In other embodiments of the aggregating compositions of this invention further include:

from about 10 wt. % to about 40 wt. % of a carrier,

where the weight percent may add to greater than 100 weight percent.

In other embodiments of the aggregating compositions of this invention further include:

from about 10 wt. % to about 30 wt. % of a carrier,

where the weight percent may add to greater than 100 weight percent.

In other embodiments of the aggregating compositions of this invention further include:

from about 10 wt. % to about 25 wt. % of a carrier,

where the weight percent may add to greater than 100 weight percent.

In other embodiments of the aggregating compositions of this invention further include:

from about 1 wt % to about 30 wt. % of a glyme,

where the weight percent may add to greater than 100 weight percent.

In other embodiments of the aggregating compositions of this invention further include:

from about 1 wt % to about 25 wt. % of a glyme,

where the weight percent may add to greater than 100 weight percent.

In other embodiments of the aggregating compositions of this invention further include:

from about 1 wt % to about 20 wt. % of a glyme,

where the weight percent may add to greater than 100 weight percent.

In other embodiments of the aggregating compositions of this invention further include:

from about 1 wt. % to about 20 wt. % of an ethoxylated alcohol having an HLB value between about 6 and about 10,

where the weight percent may add to greater than 100 weight percent.

In other embodiments of the aggregating compositions of this invention further include:

from about 1 wt. % to about 10 wt. % of an ethoxylated alcohol having an HLB value between about 6 and about 10,

where the weight percent may add to greater than 100 weight percent.

In other embodiments of the aggregating compositions of this invention further include:

from about 1 wt. % to about 8 wt. % of an ethoxylated alcohol having an HLB value between about 6 and about 10,

where the weight percent may add to greater than 100 weight percent.

Embodiments of the aggregating compositions of this invention may also be tailored to have a specific agglomerating effect on particulate material. The tailoring may be accomplished by varying the number of repeat units including an amine group in the oligomers and/or polymers, the number of non-amine containing repeat units, the number of repeat units including an ammonium group, and/or the number of repeat units including an amine oxide group. For relatively hydrophobic materials to be treated, the treating compositions should include oligomers and/or polymers including amine containing repeat units, non-amine containing groups units, or mixtures and combinations thereof. For relatively hydrophilic materials to be treated, the treating composition should include oligomer and/or polymers including ammonium containing repeat units, amine oxide containing repeat units, or mixtures and combinations thereof. By varying the relative percentages of amine containing repeat units, non-amine containing groups units, ammonium containing repeat units, and amine oxide containing repeat units, the compositions may be tailored to the exact requirements of the formation or zone. In certain embodiments, the formation, zone, and/or particle properties are determined, then the composition is tailored so that treating composition will from an adequate partial and/or complete coating on the particles and/or surfaces of the formation, zone, and/or structure.

### Experiments of the Invention

### Polymers and Oligomers Including N-Oxide Groups and Quaternary Groups

The following examples illustrate aggregating compositions including (a) polymers having N-oxide monomeric units, (b) polymers having N-oxide monomeric units and Lewis acid reaction products, (c) crosslinked polymers having N-oxide monomeric units, and (d) mixtures or combinations thereof.

### EXAMPLE 1

### P1 (195-2)

92.03 grams of a 25 wt. % solution of 15% partially oxidized poly-4-vinylpyridine, 46.11 g of Glycol Ether EB, and 46.19 g of ethylene glycol were weighed into a 400 mL beaker. The degree of oxidation of the 15% partially oxidized poly-4-vinylpyridine was measured by NMR. The concentration of the 15% partially oxidized poly-4-vinylpyridine was measured by thermogravimetric analysis (TGA). These contents were stirred with a Calframo overhead stirrer for 10 minutes at 300 rpm. Then, 18.65 g of Phosphated DA-6 available from Manufacturing Chemicals LLC were weighed into a plastic syringe and injected slowly at the beaker wall. The mixture was stirred for 90 minutes. The final product was an amber transparent liquid designated P1.

200.00 grams of 100 mesh sand were weighed into a 400 mL beaker. 200 mL of a 2 wt. % KCl solution was added to the sand. Meanwhile, 18.71 g of P1 were weighed into a plastic syringe and then added incrementally to a mixing vortex of the sand in the 2 wt. % KCl solution, which was being stirred at 450 rpm with the Calframo overhead stirrer. The vortex disappeared as P1 was added to the sand in the KCl solution. The mixture was then stirred for an additional 60 s and the liquid decanted from the sand. 200 mL of the 2 wt. % KCl solution were added to the P1 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P1 agglomerated sand descended slowly and as one piece. The P1 agglomerated sand was beige and fluffy. The P1 agglomerated sand formed a formable or reformable agglomerate that easily changed shape by the speed of mixing or the torque acting on the P1 agglomerated sand.

### EXAMPLE 2

### P2 (198-1)

165.61 g of a 25 wt. % solution of 15% partially oxidized poly-4-vinylpyridine, 9.28 g of Glycol Ether EB, and 9.26 g of ethylene glycol were weighed into a 400 mL beaker. These contents were stirred with a Calframo overhead stirrer for 10 minutes at 300 rpm. Then 16.00 g of Alpha 2240 from Weatherford was weighed into a plastic syringe and injected slowly at the beaker wall. The mixture was stirred for 90 minutes. The final product was a dark amber transparent liquid. The blend was designated P2.

200.01 g of 100 mesh sand were weighed into a 400 mL beaker. 200 mL of a 2 wt. % KCl solution were added to the sand. Meanwhile, 15.41 g of P2 were weighed into a plastic syringe. P2 was added incrementally to a vortex of the sand in the 2 wt. % KCl solution being stirred at 450 rpm with the Calframo overhead stirrer. The vortex disappeared as P2 was added to the sand in the KCL aqueous solution. Then mixture was stirred for an additional 60 s and the liquid decanted. 200 mL of the 2 wt. % KCl solution were added to the P2 agglomerated sand, stirred for 60 s and the liquid decanted. This washing step was repeated two more times. On the last washing step, the contents were poured into a 16 ounce bottle, topped off with additional 2 wt. % Kcl solution and capped. When the bottle was inverted, the P2 agglomerated sand descended slowly and as one piece. The P2 agglomerated sand was beige, fluffy and formed a formable or deformable agglomerate that easily changed shape by the speed of mixing or the torque acting on the P2 agglomerated sand.

### EXAMPLE 3

### (199-1)

200.02 g of 20/40 sand were weighed into a 400 mL beaker. 200 mL of a 2 wt. % KCl solution were added to the sand. Meanwhile, 15.44 g of P2 were weighed into a plastic syringe and added incrementally to the vortex of the sand in the 2 wt. % KCl solution being stirred at 450 rpm with the Calframo overhead stirrer. The vortex disappeared as P2 was added to the sand in the aqueous KCl solution. Then mixture was stirred for an additional 60 s and the liquid decanted.

200 mL of the 2 wt. % KCl solution were added to the P2 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P2agglomerated sand descended slowly and as one piece. The P2 agglomerated sand was beige and fluffy and forms a formable or deformable agglomerate that easily changed shape by the speed of mixing or the torque acting on the P2 agglomerated sand.

### EXAMPLE 4

### P3 (198-3)

165.64 grams of a 25 wt. % solution of 29% partially oxidized poly-4-vinylpyridine, 9.37 grams Glycol Ether EB and 10.11 grams ethylene glycol were weighed into a 400 mL beaker. The degree of oxidation of the 29% partially oxidized poly-4-vinylpyridine was measured by NMR. The concentration of the 29% partially oxidized poly-4-vinylpyridine solution was measured by Thermogravimetric Analysis (TGA). These contents were stirred with a Calframo overhead stirrer for 10 minutes at 300 rpm. Then 16.03 g of Alpha 2240 from Weatherford were weighed into a plastic syringe and injected slowly at the beaker wall. The mixture was stirred for 90 more minutes. The final product was a dark amber transparent liquid and designated P3.

### EXAMPLE 5

### P4

200 g of 100 mesh sand were weighed into a 400 mL beaker. 200 mL of a 2 wt. % KCl solution was added to the sand. Meanwhile, 14 mL of a 25 wt. % solution of 15% partially oxidized poly-4-vinylpyridine (P4) was added incrementally to a mixing vortex of the sand in the 2 wt. % KCl solution, which was being stirred at 450 rpm with the Calframo overhead stirrer. The vortex disappeared as the solution was added to the sand in the KCl solution. The mixture was then stirred for an additional 60 s and the liquid decanted from the sand. 200 mL of the 2 wt. % KCl solution were added to the P4 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P4 agglomerated sand descended slowly and as one piece as compared to untreated sand, which fell as individual sand grains.

### EXAMPLE 6

### P5

200 g of 100 mesh sand were weighed into a 400 mL beaker. 200 mL of a 2 wt. % KCl solution was added to the sand. Meanwhile, 14 mL of a 25 wt. % solution of 29% partially oxidized poly-4-vinylpyridine (P5) was added incrementally to a mixing vortex of the sand in the 2 wt. % KCl solution, which was being stirred at 450 rpm with the Calframo overhead stirrer. The vortex disappeared as P5 was added to the sand in the KCl solution. The mixture was then stirred for an additional 60 s and the liquid decanted from the sand. 200 mL of the 2 wt. % KCl solution were added to the P5 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the P5 agglomerated sand descended slowly and as one piece as compared to untreated sand, which fell as individual sand grains.

### Epoxy-Modified Amines

### EXAMPLE 7

### AE1

In a bottle, 33 g of aminoethylpiperazine, 50 g bisphenol-A diglycidyl ether, and 150 g methanol were mixed in a beaker and stirred at 300 rpm with a Calframo overhead stirrer overnight and the epoxy modified amine reaction product was designated AE1.

200 g of 100 mesh sand were weighed into a 400 mL beaker. 200 mL of a 2 wt. % KCl solution were added to the sand. Meanwhile, 14 mL of AE1 were added incrementally to a mixing vortex of the sand in the 2 wt. % KCl solution, which was being stirred at 450 rpm with a Calframo overhead stirrer. The vortex disappeared as AE1 was added to the sand in the KCl solution. The mixture was then stirred for an additional 60 s and the liquid decanted from the sand.

200 mL of the 2 wt. % KCl solution were added to the AE1 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the AE1 agglomerated sand descended slowly and as one or two pieces as compared to untreated sand which fell as individual sand grains.

### EXAMPLE 8

### AE2

In a bottle, 50 g of PAP 220, 30 g bisphenol-A diglycidyl ether, and 25 g RhodiaSolv IRIS were sealed in a bottle and placed in a 180° F. water bath overnight. The reaction mixture was then transferred to a beaker to which were added 80 g methanol and 80 g ethylene glycol and the mixture stirred at 300 rpm with a Calframo overhead stirrer. To this, 4 g of phosphate ester were added slowly and mixing continued for 1 hour and the reaction product was designated AE2.

200 g of 100 mesh sand were weighed into a 400 mL beaker. 200 mL of a 2 wt. % KCl solution were added to the sand. Meanwhile, 14 mL of AE2 were added incrementally to a mixing vortex of the sand in the 2 wt. % KCl solution, which was being stirred at 450 rpm with the Calframo overhead stirrer. The vortex disappeared as AE2 was added to the sand in the KCl solution. The mixture was then stirred for an additional 60 s and the liquid decanted from the sand.

200 mL of the 2 wt. % KCl solution were added to the AE2 agglomerated sand, stirred for 60 s and the liquid decanted. This washing step was repeated two more times. On the last washing step, the contents were poured into a 16 ounce bottle, topped off with additional 2 wt. % KCl solution and capped. When the bottle was inverted, the AE2 agglomerated sand descended slowly and as one piece as compared to untreated sand which fell as individual sand grains.

### EXAMPLE 9

### AE3

To a beaker were added 25 g of AE1 and 25 g of ethylene glycol and the mixture stirred at 300 rpm with a Calframo overhead stirrer. Next, 4 g of phosphate ester were added slowly and stirring was continued for 1 hour designated AE3.

50 grams of 20/40 mesh sand were weighed into a 250 mL beaker. 50 mL of a 2 wt. % KCl solution was added to the sand. Meanwhile, 3.5 mL of AE3 were added incrementally to a mixing vortex of the sand in the 2 wt. % KCl solution, which was being stirred at 450 rpm with the Calframo overhead stirrer. The vortex disappeared as AE3 was added to the sand in the KCl solution. The mixture was then stirred for an additional 60 s and the liquid decanted from the sand.

50 mL of the 2 wt. % KCl solution were added to the AE3 agglomerated sand, stirred for 60 s and the liquid decanted. This washing step was repeated two more times. On the last washing step, the contents were poured into a 8 ounce bottle, topped off with additional 2 wt. % KCl solution and capped. When the bottle was inverted, the AE3 agglomerated sand descended slowly and as one piece as compared to untreated sand which fell as individual sand grains.

### Acidic Hydroxyl Containing Compounds and/or Lewis Acid Reactions

The following examples illustrate aggregating compositions including (a) reaction products between amines and acidic hydroxyl containing compounds and/or Lewis acids, or mixtures and combinations thereof, (b) reaction products of polyamines and acidic hydroxyl containing compounds and/or Lewis acids, or mixtures and combinations thereof, (c) reaction products of polymeric amines acidic hydroxyl containing compounds and/or Lewis acids, or mixtures and combinations thereof, (d) crosslinked reaction products, (e) reaction products of amines and epoxy containing compounds, (f) reaction products between amine-epoxy reaction products with acidic hydroxyl containing compounds and/or Lewis acids, or mixtures and combinations thereof (e) mixtures or combinations thereof.

### EXAMPLE 10

### AC1 (166-3)

92.00 g of Reilline 400 (a 4-ethenylpyridine homopolymer available from Vertellus Specialties Inc. and other suppliers), 46.00 g of Glycol Ether EB, and 46.00 g of ethylene glycol were weighed into a 400 mL beaker. These contents were stirred with a Calframo overhead stirrer for 10 minutes at 300 rpm. Then 16.22 g of a 50 wt. % citric acid aqueous solution were weighed into a plastic syringe and injected slowly at the beaker wall. The mixture was stirred for 90 more minutes. The final product had an amber transparent liquid and was designated AC1.

200.02 g of 100 mesh sand were weighed into a 400 mL beaker. 200 mL of a 2 wt. % KCl solution were added to the sand. Meanwhile, 15.43 g of AC1 were weighed into a plastic syringe. AC1 was added incrementally to the vortex of the sand and the 2 wt. % KCl being stirred at 450 rpm with the Calframo overhead stirrer. Then that treated sand composition was stirred for an additional 60 s and the liquid decanted. 200 mL of the 2 wt. % KCl solution were added to the AC1 agglomerated sand, stirred for 60 s and the liquid decanted. This washing step was repeated two more times. On the last washing, the contents were poured into a 16 ounce bottle, topped off with additional 2 wt. % KCl solution and capped. The AC1 agglomerated sand was beige and when the bottle was inverted the AC1 agglomerated sand descended slowly and as one piece.

### EXAMPLE 11

### AC2 (176-1)

92.12 g of Reilline 400 (a 4-ethenylpyridine homopolymer available from Vertellus Specialties Inc. and other suppliers), 22.77 g of methanol, and 46.00 g of ethylene glycol were weighed into a 400 mL beaker. These contents were stirred with a Calframo overhead stirrer for 10 minutes at 300 rpm. Meanwhile, 10 g of boric acid were dissolved in 101.7 g of methanol to give a 9.0 wt. % boric acid in methanol solution. 25.89 g of the 9.0 wt. % boric acid solution was weighed into a plastic syringe and injected slowly at the beaker wall. The mixture was stirred for 90 more minutes. The final product was an amber transparent liquid and designated AC2.

200.04 g of 100 mesh sand were weighed into a 400 mL beaker. 200 mL of a 2 wt. % KCl solution were added to the sand. Meanwhile, 15.45 g of AC2 were weighed into a plastic syringe. AC2 was added incrementally to the vortex of the sand and the 2 wt. % KCl solution being stirred at 450 rpm with the Calframo overhead stirrer.

Eventually the vortex closed, the sand was viscosified and the sand sunk to the bottom of the beaker during the stirring process. Then the mixture was stirred for an additional 60 s and the liquid decanted. 200 mL of the 2 wt. % KCl solution were added to the AC2 agglomerated sand, stirred for 60 s and the liquid decanted. This washing step was repeated two more times. On the last washing, the contents were poured into a 16 ounce bottle, topped off with additional 2 wt. % KCl solution and capped. The AC2 agglomerated sand was beige and when the bottle was inverted the AC2 agglomerated sand descended slowly and as one piece.

### EXAMPLE 12

### AC3 (177-1)

92.03 g of Reilline 400 (a 4-ethenylpyridine homopolymer available from Vertellus Specialties Inc. and other suppliers), 58.03 g of methanol, and 34.02 g of ethylene glycol were weighed into a 400 mL beaker. These contents were stirred with a Calframo overhead stirrer for 10 minutes at 300 rpm. Then 18.87 g of a 40 wt. % aminoethylethanolamine tris(methylene phosphonic acid) aqueous solution were weighed into a plastic syringe and injected slowly at the beaker wall. The mixture was stirred for 90 more minutes. The final product was an amber transparent liquid and was designated AC3.

200.04 g of 100 mesh sand were weighed into a 400 mL beaker. 200 mL of a 2 wt. % KCl solution were added to the sand. Meanwhile, 15.56 g of AC3 were weighed into a plastic syringe. AC3 was added incrementally to the vortex of the sand and the 2 wt. % KCl solution being stirred at 450 rpm with the Calframo overhead stirrer.

Eventually the vortex closed, the sand was viscosified and the sand dropped to the bottom of the beaker during the stirring process. Then mixture was stirred for an additional 60 seconds and the liquid decanted. 200 mL of a 2 wt. % KCl solution were added to the AC3 agglomerated sand, stirred for 60 s and the liquid decanted. This washing step was repeated two more times. On the last washing, the contents were poured into a 16 ounce bottle, topped off with additional 2 wt. % KCl solution and capped. The AC3 agglomerated sand was beige. When the bottle was inverted, the AC3 agglomerated sand descended slowly and as one piece.

### EXAMPLE 13

### AC4 (180-1)

92.05 g of Reilline 400 (a 4-ethenylpyridine homopolymer available from Vertellus Specialties Inc. and other suppliers), 46.32 g of methanol and 46.32 g of ethylene glycol were weighed into a 400 mL beaker. These contents were stirred with a Calframo overhead stirrer for 10 minutes at 300 rpm. Then 23.59 g of an aqueous solution of 48% diethylenetriamine penta(methylene phosphonic acid) was weighed into a plastic syringe and injected slowly at the beaker wall. The mixture was stirred for 90 more minutes. The final product was an amber transparent liquid and is designated AC4.

200.03 g of 100 mesh sand were weighed into a 400 mL beaker. 200 mL of a 2 wt. % KCl solution were added to the sand. Meanwhile, 15.47 g of AC4 were weighed into a plastic syringe. AC4 was added incrementally to the vortex of the sand and the 2 wt. % KCl solution being stirred at 450 rpm with the Calframo overhead stirrer.

Eventually the vortex closed, the sand was viscosified and the sand dropped to the bottom of the beaker during the stirring process. Then that composition was stirred for an additional 60 seconds and the liquid decanted. 200 mL of a 2 wt. % KCl solution was added to the AC4 agglomerated sand, stirred for 60 seconds and the liquid decanted. This washing step was repeated two more times. On the last washing, the contents were poured into a 16 ounce bottle, topped off with additional 2 wt. % KCl solution and capped. The AC4 agglomerated sand was beige. When the bottle was inverted, the AC4 agglomerated sand descended slowly and as one piece.

### EXAMPLE 14

### AC5 (183-1)

40.04 g of Reilline 400 (a 4-ethenylpyridine homopolymer available from Vertellus Specialties Inc. and other suppliers), 70.11 g of PAP-220, 40.94 g of methanol and 40.19 g of ethylene glycol were weighed into a 400 mL beaker. These contents were stirred with a Calframo overhead stirrer for 10 minutes at 300 rpm. Then 23.50 g of an aqueous solution of 5M ZnCl₂ was weighed into a plastic syringe and injected slowly at the beaker wall. The mixture was stirred for 90 more minutes. The final product was designated AC5.

200.00 g of 20/40 sand were weighed into a 400 mL beaker. 200 mL of 2 wt. % KCl was added to the sand. Meanwhile, 15.4 g of AC5 were weighed into a plastic syringe. The blend was added incrementally to the vortex of the sand and a 2 wt. % ZnCl₂ solution being stirred at 450 rpm with the Calframo overhead stirrer. Then mixture was stirred for an additional 60 s and the liquid decanted. 200 mL of a 2 wt. % ZnCl₂ solution was added to the AC5 agglomerated sand, stirred for 60 s and the liquid decanted. This washing step was repeated two more times.

### COMPARATIVE EXAMPLE 1

### CE1 (51-1)

40.02 g of Reilline 400 (a 4-ethenylpyridine homopolymer available from Vertellus Specialties Inc. and other suppliers), 70.08 g of PAP-220, 42.84 g of methanol and 40.44 g of ethylene glycol were weighed into a 400 mL beaker. These contents were stirred with a Calframo overhead stirrer for 10 minutes at 300 rpm. Then 16.04 g of Alpha 2240 were weighed into a plastic syringe and injected slowly at the beaker wall. The mixture was stirred for 90 more minutes. The final product was designated CE1.

200.0 g of 20/40 sand were weighed into a 400 mL beaker. 200 mL of a 2 wt. % KCl solution were added to the sand. Meanwhile, 15.4 g of CE1 were weighed into a plastic syringe. The blend was added incrementally to the vortex of the sand and 2 wt. % KCl being stirred at 450 rpm with the Calframo overhead stirrer. Then that composition was stirred for an additional 60 s and the liquid decanted. 200 mL of the 2 wt. % KCl solution were added to the CE1 agglomerated sand, stirred for 60 s and the liquid decanted. This washing step was repeated two more times.

### EXAMPLE 15

### Indentation Force Testing

Indentation force in Newtons of the washed agglomerated 20/40 sands were measured with a Shimpo Model FGS-100H Manual Hand Wheel Test Stand equipped with Toriemon USB Add-in software for Excel. Sampling rate was 10 times/second. Initial force was 0.25 Newtons. TempoPerfect Metroneme Software was used to control the rate of the wheel rotation at 60 bpm. The testing data is tabulated in Table 1.

TABLE 1
Indentation Force Data

| Example | Force in Newtons |
|---|---|
| CE1 | 4.97 |
| AC5 (183-1) | 12.42 |

The indentation force for Example 15 was more than twice that of the comparative example.

### EXAMPLE 16

### AC6 (182-1)

92.03 g of Reilline 400 (a 4-ethenylpyridine homopolymer available from Vertellus Specialties Inc. and other suppliers), 46.03 g of methanol and 46.03 g of ethylene glycol were weighed into a 400 mL beaker. These contents were stirred with a Calframo overhead stirrer for 10 minutes at 300 rpm. Then 14.76 g of Westvaco Diacid 1550 was weighed into a plastic syringe and injected slowly at the beaker wall. The mixture was stirred for 90 more minutes. The final product was an amber transparent liquid and was designated AC6.

200.06 g of 100 mesh sand was weighed into a 400 mL beaker. 200 mL of 2 wt. % KCl was added to the sand. Meanwhile, 15.44 g of AC6 were weighed into a plastic syringe. AC6 was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. Then mixture was stirred for an additional 60 s and the liquid decanted. 200 mL of 2 wt. % KCl was added to the AC6 agglomerated sand, stirred for 60 s and the liquid decanted. This washing step was repeated two more times. On the last washing, the contents were poured into a 16 ounce bottle, topped off with additional 2 wt. % KCl solution and capped. The AC6 agglomerated sand was beige. When the bottle was inverted, the AC6 agglomerated sand descended slowly and as one piece.

### EXAMPLE 17

### AC7 (186-1)

92.03 g of Reilline 400 (a 4-ethenylpyridine homopolymer available from Vertellus Specialties Inc. and other suppliers), 7.62 g of Dowanol EB and 46.17 g of ethylene glycol were weighed into a 400 mL beaker. These contents were stirred with a Calframo overhead stirrer for 10 minutes at 300 rpm. Meanwhile, 29.17 g of Tenax 201 was dissolved in Glycol Ether EB to give a 28.28 wt. % solution of Tenax 2010 in Dowanol EB. Then 53.75 g of the 28.28 wt. % solution of Tena 2010 in Dowanol EB was weighed into a plastic syringe and injected slowly at the beaker wall. The mixture was stirred for 90 more minutes. The final product was an amber transparent liquid and was designated AC7.

200.03 g of 100 mesh sand was weighed into a 400 mL beaker. 200 mL of 2 wt. % KCl was added to the sand. Meanwhile, 15.45 g of AC7 were weighed into a plastic syringe. AC7 was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. The mixture was stirred for an additional 60 s and the liquid decanted. 200 mL of 2 wt. % KCl was added to the AC7 agglomerated sand, stirred for 60 seconds and the liquid decanted. This washing step was repeated two more times. On the last washing, the contents were poured into a 16 ounce bottle, topped off with additional 2 wt. % KCl solution and capped. The AC7 agglomerated sand was beige. When the bottle was inverted, the AC7 agglomerated sand descended slowly and as one piece.

### EXAMPLE 18

### AC8 (182-3)

92.02 g of Reilline 400 (a 4-ethenylpyridine homopolymer available from Vertellus Specialties Inc. and other suppliers), 37.81 g of methanol and 46.01 g of ethylene glycol were weighed into a 400 mL beaker. These contents were stirred with a Calframo overhead stirrer for 10 minutes at 300 rpm. Meanwhile, 30.00 g of maleic acid was dissolved in 50.09 g of methanol to give a 37.46 wt. % solution of maleic acid in methanol. Then 13.12 g of the 37.46 wt. % solution of maleic acid in methanol was weighed into a plastic syringe and injected slowly at the beaker wall. The mixture was stirred for 90 more minutes. The final product was an amber transparent liquid and was designated AC8.

200.09 g of 100 mesh sand was weighed into a 400 mL beaker. 200 mL of 2 wt. % KCl was added to the sand. Meanwhile, 15.46 g of AC8 were weighed into a plastic syringe. AC8 was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. The mixture was stirred for an additional 60 s and the liquid decanted. 200 mL of 2 wt. % KCl was added to the AC8 agglomerated sand, stirred for 60 s and the liquid decanted. This washing step was repeated two more times. On the last washing, the contents were poured into a 16 ounce bottle, topped off with additional 2 wt. % KCl solution and capped. The AC8 agglomerated sand was beige. When the bottle was inverted, the AC8 agglomerated sand descended slowly and as one piece.

### EXAMPLE 19

### AC9 (184-2)

92.05 g of Reilline 400 (a 4-ethenylpyridine homopolymer available from Vertellus Specialties Inc. and other suppliers) and 46.40 g of ethylene glycol were weighed into a 400 mL beaker. These contents were stirred with a Calframo overhead stirrer for 10 minutes at 300 rpm. Meanwhile, 13.03 g of succinic acid was dissolved in 139.25 g of methanol to give an 8.56 wt. % solution of succinic acid in methanol. Then 53.18 g of the 8.56 wt. % solution of succinic acid in methanol was weighed into a plastic syringe and injected slowly at the beaker wall. The mixture was stirred for 90 more minutes. The final product was an amber transparent liquid and was designated AC9.

200.09 g of 100 mesh sand was weighed into a 400 mL beaker. 200 mL of 2 wt. % KCl was added to the sand. Meanwhile, 15.46 g of AC9 were weighed into a plastic syringe. The blend was added incrementally to the vortex of the sand and 2 wt. % KCl being stirred at 450 rpm with the Calframo overhead stirrer. Eventually the vortex closed, the sand was viscosified and the sand dropped to the bottom of the beaker during the stirring process. Then mixture was stirred for an additional 60 s and the liquid decanted. 200 mL of the 2 wt. % KCl solution was added to the agglomerated sand, stirred for 60 s and the liquid decanted. This washing step was repeated two more times. On the last washing, the contents were poured into a 16 ounce bottle, topped off with additional 2 wt. % KCl solution and capped. The AC9 agglomerated sand was beige. When the bottle was inverted, the AC9 agglomerated sand descended slowly and as one piece.

### EXAMPLE 20

### AC10 (185-1)

92.04 g of Reilline 400 (a 4-ethenylpyridine homopolymer available from Vertellus Specialties Inc. and other suppliers) and 46.40 g of ethylene glycol were weighed into a 400 mL beaker. These contents were stirred with a Calframo overhead stirrer for 10 minutes at 300 rpm. Meanwhile, 13.08 g of adipic acid was dissolved in 140.11 g of methanol to give an 8.53 wt. % solution of adipic acid in methanol. Then 72.28 g of the 8.53 wt. % solution of adipic acid in methanol was weighed into a plastic syringe and injected slowly at the beaker wall. The mixture was stirred for 90 more minutes. The final product was an amber transparent liquid and was designated AC10.

200.01 g of 100 mesh sand was weighed into a 400 mL beaker. 200 mL of 2 wt. % KCl was added to the sand. Meanwhile, 15.42 g of AC 10 were weighed into a plastic syringe. The blend was added incrementally to the vortex of the sand and 2 wt. % KCl being stirred at 450 rpm with the Calframo overhead stirrer. The vortex disappeared after addition of 7 mL of the Reilline 400 and adipic acid blend and the sand dropped to the bottom of the beaker during the stirring process. Then that composition was stirred for an additional 60 seconds and the liquid decanted. 200 mL of the 2 wt. % KCl solution was added to the AC10 agglomerated sand, stirred for 60 s and the liquid decanted. This washing step was repeated two more times. On the last washing, the contents were poured into a 16 ounce bottle, topped off with additional 2 wt. % KCl solution and capped. The AC10 agglomerated sand was beige. When the bottle was inverted, the AC10 agglomerated sand descended slowly and as one piece.

### EXAMPLE 21

### AC11 (187-3)

92.01 g of Reilline 400 (a 4-ethenylpyridine homopolymer available from Vertellus Specialties Inc. and other suppliers), 25.58 g of methanol and 46.02 g of ethylene glycol were weighed into a 400 mL beaker. These contents were stirred with a Calframo overhead stirrer for 10 minutes at 300 rpm. Meanwhile, 25.60 g of tricarballylic acid was dissolved in 70.44 g of methanol to give a 26.65 wt. % solution of carballylic acid in methanol. Then 27.91 g of the 26.65 wt. % solution of carballylic acid in methanol was weighed into a plastic syringe and injected slowly at the beaker wall. The mixture was stirred for 90 more minutes. The final product was an amber transparent liquid and was designated AC11.

200.05 g of 100 mesh sand was weighed into a 400 mL beaker. 200 mL of 2 wt. % KCl was added to the sand. Meanwhile, 15.43 g of AC11 were weighed into a plastic syringe. The blend was added incrementally to the vortex of the sand and 2 wt. % KCl being stirred at 450 rpm with the Calframo overhead stirrer. The vortex disappeared after the addition of 5 mL of the reaction product of Reilline 400 and carballylic acid in methanol and ethylene glycol and the sand dropped to the bottom of the beaker after the addition of 5 mL of the reaction product of Reilline 400 and carballylic acid during the stirring process. Then that composition was stirred for an additional 60 seconds and the liquid decanted. 200 mL of the 2 wt. % KCl solution was added to the AC11 agglomerated sand, stirred for 60 s and the liquid decanted. This washing step was repeated two more times. On the last washing, the contents were poured into a 16 ounce bottle, topped off with additional 2 wt. % KCl and capped. The AC11 agglomerated sand was beige. When the bottle was inverted, the AC11 agglomerated sand descended slowly and as one piece.

### EXAMPLE 22

### AC12 (187-1)

92.05 g of Reilline 400 (a 4-ethenylpyridine homopolymer available from Vertellus Specialties Inc. and other suppliers), 35.89 g of methanol and 46.00 g of ethylene glycol were weighed into a 400 mL beaker. These contents were stirred with a Calframo overhead stirrer for 10 minutes at 300 rpm. Meanwhile, 14.19 g of p-toluene sulfonic acid monohydrate was dissolved in 18.04 g of methanol to give a 44.03 wt. % solution of p-toluene sulfonic acid monohydrate in methanol. Then 18.28 g of the 44.03 wt. % solution of p-toluene sulfonic acid monohydrate in methanol was weighed into a plastic syringe and injected slowly at the beaker wall. The mixture was stirred for 90 more minutes. The final product was an amber transparent liquid and was designated AC12.

200.04 g of 100 mesh sand was weighed into a 400 mL beaker. 200 mL of 2 wt. % KCl was added to the sand. Meanwhile, 15.43 g of AC12 were weighed into a plastic syringe. The blend was added incrementally to the vortex of the sand and 2 wt. % KCl being stirred at 450 rpm with the Calframo overhead stirrer. The vortex disappeared early and the sand dropped to the bottom of the beaker during the stirring process. Then mixture was stirred for an additional 60 s and the liquid decanted. 200 mL of the 2 wt. % KCl solution was added to the AC12 agglomerated sand, stirred for 60 s and the liquid decanted. This washing step was repeated two more times. On the last washing, the contents were poured into a 16 ounce bottle, topped off with additional 2 wt. % KCl solution and capped. The AC12 agglomerated sand was beige. When the bottle was inverted, the AC22 agglomerated sand descended slowly and as one piece.

### EXAMPLE 23

### AC13 (188-1)

92.05 g of Reilline 400 (a 4-ethenylpyridine homopolymer available from Vertellus Specialties Inc. and other suppliers), 43.36 g of methanol and 46.03 g of ethylene glycol were weighed into a 400 mL beaker. These contents were stirred with a Calframo overhead stirrer for 10 minutes at 300 rpm. Meanwhile, 21.72 g of glacial acetic acid was dissolved in 21.74 g of methanol to give a 49.98 wt. % solution of glacial acetic acid in methanol. Then 5.08 g of the 49.98 wt. % solution of glacial acetic acid in methanol was weighed into a plastic syringe and injected slowly at the beaker wall. The mixture was stirred for 90 more minutes. The final product was an amber transparent liquid and was designated AC13.

200.03 g of 100 mesh sand was weighed into a 400 mL beaker. 200 mL of 2 wt. % KCl was added to the sand. Meanwhile, 15.41 g of AC13 were weighed into a plastic syringe. The AC13 was added incrementally to the vortex of the sand and 2 wt. % KCl being stirred at 450 rpm with the Calframo overhead stirrer. The vortex disappeared early and the sand dropped to the bottom of the beaker during the stirring process. Then mixture was stirred for an additional 60 s and the liquid decanted.

200 mL of the 2 wt. % KCl solution was added to the AC13 agglomerated sand, stirred for 60 s and the liquid decanted. This washing step was repeated two more times. On the last washing, the contents were poured into a 16 ounce bottle, topped off with additional 2 wt. % KCl solution and capped. The AC13 agglomerated sand was beige. When the bottle was inverted, the AC13 agglomerated sand descended slowly and as one piece.

### EXAMPLE 24

### AC14 (209-3)

92.03 g of HAP-310 from Vertellus Specialties Inc., 46.21 g Dowanol DPM glycol ether, and 46.05 g ethylene glycol were weighed into a 400 mL beaker. These contents were stirred with a Calframo overhead stirrer for 10 minutes at 300 rpm. Then 16.24 g of a 50.0 wt. % solution of citric acid in water were weighed into a plastic syringe and injected slowly at the beaker wall. The mixture was stirred for 90 more minutes. The final product was a black opaque liquid and was designated AC14.

200.08 g of 100 mesh sand were weighed into a 400 mL beaker. 200 mL of a 2 wt. % KCl solution were added to the sand. Meanwhile, 15.45 g of AC14 were weighed into a plastic syringe. The AC14 was added incrementally to the vortex of the sand and 2 wt. % KCl solution being stirred at 450 rpm with the Calframo overhead stirrer. The vortex disappeared after 5.45 g of AC14 were added and the sand dropped during the stirring process. The remaining 10 g of AC14 were added during the stirring process. Then that composition was stirred for an additional 60 seconds and the liquid decanted.

200 mL of 2 wt. % KCl solution were added to the AC14 agglomerated sand, stirred for 60 seconds and the liquid decanted. This washing step was repeated two more times. On the last washing, the contents were poured into a 16 ounce bottle, topped off with additional 2 wt. % KCl solution and capped. The AC14 agglomerated sand was black. When the bottle was inverted the next day, the AC14 agglomerated sand descended slowly as one piece.

### EXAMPLE 25

### AC15 (212-3)

92.06 g of HAP-310 from Vertellus Specialties Inc., 37.85 g of methanol, and 46.00 g ethylene glycol were weighed into a 400 mL beaker. The viscosity of the HAP-310 was determined to be 6899 cps at 25° C. with a Brookfield DV-II Pro viscometer equipped with a small sample adapter, circulating bath and spindle S-34. These contents were stirred with a Calframo overhead stirrer for 10 minutes at 300 rpm. Meanwhile, 30.06 g maleic acid was dissolved in 50.05 g methanol to give a 37.52 wt. % solution of maleic acid in methanol. Then 13.09 g of the 50.0 wt. % solution of citric acid in water were weighed into a plastic syringe and injected slowly at the beaker wall. The mixture was stirred for 90 more minutes. The final product was a black opaque liquid and was designated AC15.

200.00 grams of 100 mesh sand was weighed into a 400 ml beaker. 200 mL of 2 wt. % KCl were added to the sand. Meanwhile, 15.48 g of AC15 were weighed into a plastic syringe. The AC15 was added incrementally to the vortex of the sand and a 2 wt. % KCl solution being stirred at 450 rpm with the Calframo overhead stirrer. The vortex disappeared after 4.26 grams of AC15 were added during the stirring process. The remaining 11.22 g of AC15 were added during the stirring process. Then that mixture was stirred for an additional 60 seconds and the liquid decanted.

200 mL of 2 wt. % KCl solution were added to the AC15 agglomerated sand, stirred for 60 seconds and the liquid decanted. This washing step was repeated two more times. On the last washing, the contents were poured into a 16 ounce bottle, topped off with additional 2 wt. % KCl solution and capped. The AC15 agglomerated sand was black. When the bottle was inverted a day later, the AC15 agglomerated sand descended slowly as one piece then broke into two pieces.

### EXAMPLE 26

### AC16 (213-2)

92.06 g HAP-310 from Vertellus Specialties Inc., 46.75 g Dowanol DPM glycol ether, and 46.00 g ethylene glycol were weighed into a 400 mL beaker. The viscosity of the HAP-310 was determined to be 6899 cps at 25° C. with a Brookfield DV-II Pro viscometer equipped with a small sample adapter, circulating bath and spindle S-34. These contents were stirred with a Calframo overhead stirrer for 10 minutes at 300 rpm. Then 14.84 g of Westvaco Diacid 1550 was weighed into a plastic syringe and injected slowly at the beaker wall. The mixture was stirred for 90 more minutes. The final product was a black opaque liquid and was designated AC16.

200.00 g of 100 mesh sand was weighed into a 400 mL beaker. 200 mL of a 2 wt. % KCl solution was added to the sand. Meanwhile, 15.48 g AC16 were weighed into a plastic syringe. The AC26 was added incrementally to the vortex of the sand and 2 wt. % KCl solution being stirred at 450 rpm with the Calframo overhead stirrer. The vortex disappeared after 5.02 g of AC16 were added during the stirring process. The remaining 10.46 g of AC16 were added during the stirring process. Then that mixture was stirred for an additional 60 seconds and the liquid decanted.

200 mL of 2 wt. % KCl solution were added to the AC16 agglomerated sand, stirred for 60 seconds and the liquid decanted. This washing step was repeated two more times. On the last washing, the contents were poured into a 16 ounce bottle, topped off with additional 2 wt. % KCl solution and capped. The AC16 agglomerated sand was black. When the bottle was inverted a day later, the AC16 agglomerated sand descended slowly as one piece, then broke into two pieces and each piece crumbled.

### EXAMPLE 27

### AC17 (210-1)

46.02 g HAP-310 and 46.03 grams PAP-220 from Vertellus Specialties Inc., 46.38 g methanol, and 46.22 g ethylene glycol were weighed into a 400 mL beaker. These contents were stirred with a Calframo overhead stirrer for 10 minutes at 300 rpm. Then 14.80 g of Westvaco Diacid 1550 were weighed into a plastic syringe and injected slowly at the beaker wall. The mixture was stirred for 90 more minutes. The final product was a black opaque liquid and was designated AC17.

200.06 g of 100 mesh sand was weighed into a 400 mL beaker. 200 mL of a 2 wt. % KCl solution were added to the sand. Meanwhile, 15.48 g of AC17 were weighed into a plastic syringe. The AC27 were added incrementally to the vortex of the sand and 2 wt. % KCl solution being stirred at 450 rpm with the Calframo overhead stirrer. The vortex disappeared after 2.54 g of AC17 were added during the stirring process. The remaining 12.94 g of AC17 were then added. Then that mixture was stirred for an additional 60 seconds and the liquid decanted.

200 milliliters of 2 wt. % KCl was added to the AC17 agglomerated sand, stirred for 60 seconds and the liquid decanted. This washing step was repeated two more times. On the last washing, the contents were poured into a 16 ounce bottle, topped off with additional 2 wt. % KCl solution and capped. The AC17 agglomerated sand was black. When the bottle was inverted a day later, the AC17 agglomerated sand descended slowly as one piece, then crumbled.

### COMPARATIVE EXAMPLE 2

### CE2 (213-1)

92.05 g of HAP-310 from Vertellus Specialties Inc., 46.03 g of methanol, and 46.07 g of ethylene glycol were weighed into a 400 mL beaker. The viscosity of the HAP-310 was determined to be 6899 cps at 25° C with a Brookfield DV-II Pro viscometer equipped with a small sample adapter, circulating bath and spindle S-34. These contents were stirred with a Calframo overhead stirrer for 10 minutes at 300 rpm. No organic acid was added. The mixture was stirred for 90 more minutes. The final product was a black opaque liquid and was designated CE2.

200.04 g of 100 mesh sand was weighed into a 400 mL beaker. 200 mL of a 2 wt. % KCl solution were added to the sand. Meanwhile, 15.43 g of CE2 were weighed into a plastic syringe. The CE2 was added incrementally to the vortex of the sand and 2 wt. % KCl solution being stirred at 450 rpm with the Calframo overhead stirrer. The vortex disappeared after 6.4 g of CE2 were added and the sand dropped a ¼ inch during the stirring process. The remaining 9.03 g of CE2 werer added during the stirring process. Then that composition was stirred for an additional 60 seconds and the liquid decanted.

200 mL of 2 wt. % KCl solution were added to the agglomerated sand, stirred for 60 seconds and the liquid decanted. This washing step was repeated two more times. On the last washing, the contents were poured into a 16 ounce bottle, topped off with additional 2 wt. % KCl solution and capped. The CE2 agglomerated sand was black. When the bottle was inverted a day later, the CE2 agglomerated sand descended slowly as one piece, then broke into two pieces and then each piece crumbled.

### EXAMPLE 28

### Comparative Indentation Testing

Indentation force (g) was measured at 25° C. with a TA HD Plus Texture Analyser from Texture Technologies Corp. The test mode was compression, the pre-test speed was 3.0 mm/s, test speed was 2.0 mm/s, post-test speed was 10 mm/s, target was distance, distance was 10.0 mm and trigger force was 5.0 g. The 2 wt. % KCL solution was decanted and each agglomerated 100 mesh sand was transferred to a mold or vessel, where it was compressed at 500 foot pounds with a Carver press. Four indentation measurements were obtained per sample and then averaged. The testing data is tabulated in Table 2.

TABLE 2
Indentation Force Measurements

| Samples | Average Force (g) |
|---|---|
| CE2 (213-1) | 229 |
| AC15 (209-3) | 373 |
| AC16 (212-3) | 282 |

CE2 (213-1) was agglomerated without an organic acid or phosphate ester. The alkylpyridines in CE2 (213-1) are protonated from water in the washing and decanting steps with 2 wt. % KCl solution. AC15 (209-3) and AC16 (212-3) were protonated with an organic acid. More indentation force was observed when protonated with an organic acid.

### Resins and Cross-Linkers

### EXAMPLE 29

### R1

120 g of a 4-ethenylpyridine homopolymer, 33 g of dimethyl 2-methylglutarate and 33 g of ethylene glycol were weighed into a 400 mL beaker. These contents were stirred with a Calframo overhead stirrer for 10 minutes at 300 rpm. Then 6.5 g of acetic acid was weighed into a plastic syringe and injected slowly into the beaker. The mixture was stirred for 90 more minutes. The final product was an amber transparent liquid and is designated 1R.

### EXAMPLE 30

### R2

To 9.5 g of R1 was added 0.5 g phenolic resole resin and mixed in a bottle until a uniform solution was formed. The final product was an amber transparent liquid and is designated R2.

### EXAMPLE 31

### Measurement of Compressive Strength

Agglomerated 25 g of 100 mesh sand using 5 mL of R2 in 50 mL 2% KCl solution followed by 1 wash with 50 mL 2% KCl . Next, 20 g of this sample was placed into a 1″ cement mold and pressed to 500 psi to make a uniform sample. This sample was immersed in a 2% KCl solution which was placed in a water bath at 180° F. for 3 days. The sample was then cooled to room temperature, removed from the mold, and the compressive strength measured using a Texture Technologies TA-HDPlus instrument. Compressive strength was measured at 1100 psi.

### EXAMPLE 32

### R3

To 8.5 g of a solution with formulation similar to AC16 was added 1.5 g of bisphenol A diglycidyl ether and the mixture shaken until a uniform solution was formed. The final product as a dark black, uniform solution and is designated R3.

### EXAMPLE 33

### Measurement of Compressive Strength

Next, 40 g of 100 mesh sand in 40 mL 2% KCl was agglomerated with 2.8 mL of R3 followed by 3 post-flushes with 40 mL 2% KCl . Next, 20 g of this sample was placed into a 1″ cement mold and pressed to 500 psi to make a uniform sample. This sample was immersed in a 2% KCl solution which was placed in a water bath at 180° F. for 1 day. The sample was then removed from the mold, and the compressive strength was immediately measured. Compressive strength was measured at 546 psi.

### EXAMPLE 34

### R4

92 g of a 4-ethenylpyridine homopolymer, 46 g of a glycol ether and 46 g of ethylene glycol were weighed into a 400 mL beaker. These contents were stirred with a Calframo overhead stirrer for 10 minutes at 300 rpm. Then 2.2 g of acetic acid was weighed into a plastic syringe and injected slowly into the beaker. The mixture was stirred for 90 more minutes. The final product was an amber transparent liquid and is designated R4.

### EXAMPLE 35

### R5

To 9.75 g of R4 was added 0.25 g 1,6-dibromohexane and the mixture shaken until a uniform solution was formed. The final product was an amber transparent liquid and is designated R5.

### EXAMPLE 36

Agglomerated 25 g of 100 mesh sand using 5 mL of R5 in 50 mL 2% KCl solution followed by 1 wash with 50 mL 2% KCl . Next, 20 g of this sample was placed into a 1″ cement mold and pressed to 500 psi to make a uniform sample. This sample was immersed in a 2% KCl solution which was placed in a water bath at 180° F. for 1 day. The sample was then removed from the mold and the compressive strength was immediately measured. Compressive strength was measured at 113 psi.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A method for altering the self-aggregating properties and/or aggregations propensities of particles, surfaces and/or materials in a downhole application comprising the step of:
contacting particles, surfaces and/or materials with an aggregating composition comprising
(i) oligomeric amines or polymeric amines of:
a. vinyl amine monomers
b. acrylate amine monomers
c. vinyl ether amine monomers
(ii) oligoethylenimines or polyethylenimines.
(iii) oligoenamines or polynamines.
(iv) oligoimines or polymines.
(v) biooligomers or biopolymers including amine groups, and
(vi) mixtures and combinations of (i) to (v).
and where the composition forms partial, substantially complete, and/or complete coatings on the particles, surfaces and/or materials altering their self-aggregating properties and/or aggregation propensities.

2. The method of claim 1, wherein the relative amounts of (i) to (v) are adjusted to the exact requirements of the formation, zone, particles and/or structure to be treated.

3. (canceled)

4. The method of claim 1, wherein the aggregating composition further includes a carrier.

5. The method of claim 1, wherein the aggregating composition further includes ethoxylated alcohols, esters, and/or glymes.

6. (canceled)

7. (canceled)

8. A method for controlling sand or fines migration comprising the step of:
pumping a fluid into a formation at a rate and a pressure to control sand and fine production or migration into the production fluids, where the fluid includes an aggregating composition comprising
(i) oligomeric amines of polymeric amines of:
a. vinyl amine monomers
b. acrylate amine monomers
c. vinyl ether amine monomers
(ii) oligoethylenimines or polyethylenimines,
(iii) oligoenamines or polynamines,
(iv) oligoimines or polyimines,
(v) biooligomers or biopolymers including amine groups, and
(vi) mixtures and combinations of (i) to (v),
and where the composition forms partial, substantially complete, and/or complete coatings on the particles, surfaces and/or materials altering their self-aggregating properties and/or aggregation propensities.

9. The method of claim 8, wherein the relative amounts of (i) to (v) are adjusted to the exact requirements of the formation, zone, particles and/or structure to be treated.

10. The method of claim 8, wherein the coating composition further includes a carrier.

11. The method of claim 8, wherein the aggregating composition further includes ethoxylated alcohols, esters, alkyl pyridines, and/or glymes.

12. A method for controlling sand or fines migration comprising the step of:
depositing a coated particulate solid material treated with a treating composition comprising
(i) oligomeric amines or polymeric amines of:
a. vinyl amine monomers
b. acrylate amine monomers
c. vinyl ether amine monomers
(ii) oligoethylenimines or polyethylenimines,
(iii) oligoenamines or polyenamines,
(iv) oligoimines or polyimines,
(v) biooligomers or biopolymers including amine groups, and
(vi) mixtures and combinations of (i) to (v),
and where the composition forms partial, substantially complete, and/or complete coatings on the particles, surfaces and/or materials altering their self-aggregating properties and/or aggregation propensities adjacent screen-type sand and fines control devices so that the sand and/or fines are attracted to the coated particles and do not encounter or foul the screen of the screen-type device.

13. The method of claim 12, wherein the relative amounts of (i) to (v) are adjusted to the exact requirements of the formation, zone, particles and/or structure to be treated.

14. (canceled)

15. The method of claim 12, wherein the coating composition further includes a carrier.

16. The method of claim 12, wherein the aggregating composition further includes ethoxylated alcohols, esters, alkyl pyridines, and/or glymes.

17. A composition comprising a particulate material including a surface having a partial or complete coating deposited thereon, where the coating comprising an aggregating composition comprising
(i) oligomeric amines or polymeric amines of:
a. vinyl amine monomers
b. acrylate amine monomers
c. vinyl ether amine monomers
(ii) oligoethylenimines or polyethylenimines
(iii) oligoenamines or polyenamines,
(iv) oligoimines or polyimines,
(v) biooligomers or biopolymers including amine groups, and
(vi) mixtures and combinations of (i) to (v),
and where the composition forms partial, substantially complete, and/or complete coatings on the particles, surfaces and/or materials altering their self-aggregating properties and/or aggregation propensities.

18. The composition of claim 17, wherein the relative amounts of (i) to (v) are adjusted to the exact requirements of the formation, zone, particles and/or structure to be treated.

19. (canceled)

20. The composition of claim 17, wherein the coating composition further includes a carrier.

21. The composition of claim 17, wherein the aggregating composition further includes ethoxylated alcohols, esters, alkyl pyridines, and/or glymes.

22. A substrate comprising surfaces partially or completed coated with a coating composition comprising an aggregating composition comprising
(i) oligomeric amines or polymeric amines of:
a. vinyl amine monomers
b. acrylate amine monomers
c. vinyl ether amine monomers
(ii) oligoethylenimines or polyethylenimines,
(iii) oligoenamines or polyenamines,
(iv) oligoimines or polyimines,
(v) biooligomers or biopolymers including amine groups, and
(vi) mixtures and combinations of (i) to (v),
and where the composition forms partial, substantially complete, and/or complete coatings on the particles, surfaces and/or materials altering their self-aggregating properties and/or aggregation propensities, where the coating is deformable and where the substrate is ideally suited for filtering fines and/or other particulate materials form a fluid, especially fluids used in oil/gas well drilling, completion, production, fracturing, propping, other production enhancing processes or other related applications.

23. The substrate of claim 22, wherein the relative amounts of (i) to (v) are adjusted to the exact requirements of the formation, zone, particles and/or structure to be treated.

24. (canceled)

25. The substrate of claim 22, wherein the coating composition further includes a carrier.

26. The substrate of claim 22, wherein the aggregating composition further includes ethoxylated alcohols, esters, alkyl pyridines, and/or glymes.
